(19) United States
(12) Patent Application Publication
(10) Pub. No.: US 2026/0342658 A1
(43) Pub. Date: Oct. 29, 2026

(54) SYSTEMS AND METHODS FOR COMMAND AND CONTROL OF A UNIFIED INTERNET OF THINGS CONFIGURATION AND REPORTING PLATFORM

(71) Applicant: Verizon Patent and Licensing Inc., Basking Ridge, NJ (US)

(72) Inventors: Wujun Qie, Needham, MA (US); Chandrababu Naidu Kamani, McKinney, TX (US); Shweta Agarwal, Franklin, MA (US); Adriana M. Rincon, Land O' Lakes, FL (US); Srirama R. Kalidindi, Flower Mound, TX (US); Jaykishan Tiwari, Irving, TX (US); Pratod V. Kasbekar, Manalapan, NJ (US); Prabhjot Kaur, Sharon, MA (US); Yagiz Onat Yazir, Hollis, NH (US); Saurabh Bhatnagar, Westborough, MA (US)

(73) Assignee: Verizon Patent and Licensing Inc., Basking Ridge, NJ (US)

(21) Appl. No.: 19/192,310

(22) Filed: Apr. 28, 2025

(51) Int. Cl. H04L 41/08; H04W 52/02; H04W 76/25

(52) U.S. Cl. CPC H04L 41/0879; H04W 52/0203; H04W 76/25

(57) ABSTRACT

A system described herein may maintain downlink formatting information associated with a plurality of different Internet of Things (“IoT”) devices. The downlink formatting information for a particular IoT device may include a format of configuration instructions used to configure parameters of the particular IoT device. The system may generate a user interface (“UI”) that includes an option to configure one or more parameters of the particular IoT device, and may present the UI to a user device. The system may receive, from the user device, a selection of a particular option to configure a particular parameter of the particular IoT device. The system may generate, based on the format of configuration instructions for the particular IoT device, a set of configuration instructions based on the received selection of the particular option; and output the set of configuration instructions to the IoT device.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. IoT devices may include, for example, sensors (e.g., temperature sensors, motion sensors, water sensors, or the like), smart home devices, or the like. Planning, deploying, and managing a complete IoT infrastructure faces challenges such as disparate IoT device types (e.g., different manufacturers, models, hardware types, etc.), a lack of real time (or near-real time) insights into IoT device operational health, uncertainty over maximizing future scalability, requirements for technical expertise in integrating IoT devices with existing infrastructure, security concerns, among other challenges.

### BRIEF DESCRIPTION OF THE DRAWINGS

FIG. 1 illustrates an example overview of one or more embodiments described herein;

FIGS. 2-4 illustrate example deployments of different types of IoT devices and/or gateways that utilize different communication technologies, in accordance with some embodiments;

FIG. 5 illustrates an example of different domains to which different sets of IoT devices may belong, in accordance with some embodiments;

FIG. 6 illustrates an example of accessing uplink and/or downlink information associated with IoT devices of a domain, in accordance with some embodiments;

FIG. 7 illustrates an example of IoT device-specific information that may be used to present uplink and/or downlink information associated with different IoT device types via a unified system, in accordance with some embodiments;

FIG. 8 illustrates an example of registering one or more IoT gateways, in accordance with some embodiments;

FIGS. 9-14 illustrate example user interfaces associated with a unified IoT control interface, in accordance with some embodiments;

FIG. 15 illustrates an example of modifying configuration parameters of an IoT device based on inputs received via the unified IoT control interface of some embodiments;

FIG. 16 illustrates an example of modifying configuration parameters of an IoT device and one or more IoT gateways based on inputs received via the unified IoT control interface of some embodiments;

FIG. 17 illustrates an example process for providing and implementing a unified IoT control interface, in accordance with some embodiments, in accordance with some embodiments;

FIGS. 18 and 19 illustrate example environments in which one or more embodiments, described herein, may be implemented;

FIG. 20 illustrates an example arrangement of a radio access network (“RAN”), in accordance with some embodiments; and

FIG. 21 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide a unified IoT infrastructure that provides for a seamless onboarding of a variety of different types of IoT devices, as well as a single point of access for configuration and reporting for multiple different IoT devices with varying characteristics. Such characteristics may include, for example, different manufacturers and/or models of IoT devices, different IoT device types or categories (e.g., temperature sensors, motion sensors, water sensors, etc.), IoT devices with different communication technologies or protocols (e.g., wireless technologies or protocols such as Bluetooth® Low Energy (“BLE”®) or Long Range Wide Area Network (“LoRaWAN”®), or wired technologies or protocols such as IO-Link®), or other differentiating characteristics. In one example, some IoT devices may be rated for various types of interior use (e.g., within warehouses, industrial facilities, or the like), while other IoT devices may be rated for rugged exterior use (e.g., in agricultural or other outdoor applications). As noted above, implementing an environment or infrastructure that incorporates a wide variety of IoT devices with their differing characteristics may pose technical challenges, logistical challenges, and/or other challenges. The unified IoT infrastructure described herein solves such challenges, thus allowing the seamless and easy deployment, configuration, and monitoring of a variety of different types of IoT devices (e.g., in a manner that is “agnostic” to the differing characteristics of the IoT devices) via a single, easy to access interface.

For example, as discussed below, a user such as an administrator, an operator, operations or support staff, or the like, may be able to quickly and easily access configuration parameters or reporting information associated with various types of IoT devices via a unified interface provided by a Unified IoT Configuration and Reporting Platform (“UICRP”) of some embodiments. As discussed herein, for example, a particular organization or other type of entity may be associated with a particular “domain” out of a set of domains, where each domain includes a particular set of IoT devices as well as a set of authorized users or user groups. Different users may have different levels of access (e.g., administrator, read only, etc.) and/or may be able to access different IoT devices of a domain (e.g., authorized to access or configure a first IoT device of the domain without being authorized to access or configure a second IoT device of the domain). The UICRP of some embodiments may provide a unified interface and point of access, whereby users are able to securely (i.e., secure from the standpoint of the users as well as from the standpoint of entities that own, operate, or deploy the IoT devices) configure, monitor, manage, etc. multiple different IoT devices, without needing to individually connect to or otherwise directly communicate with multiple different IoT devices, thereby simplifying and enhancing the user experience of a diverse IoT deployment. Further, as discussed below, inputs received via a unified IoT control interface of some embodiments may cause the initiation of network-based operations, such as communicating with multiple LoRaWAN devices to configure or modify configuration parameters associated with LoRaWAN IoT devices communicatively coupled to such LoRaWAN devices.

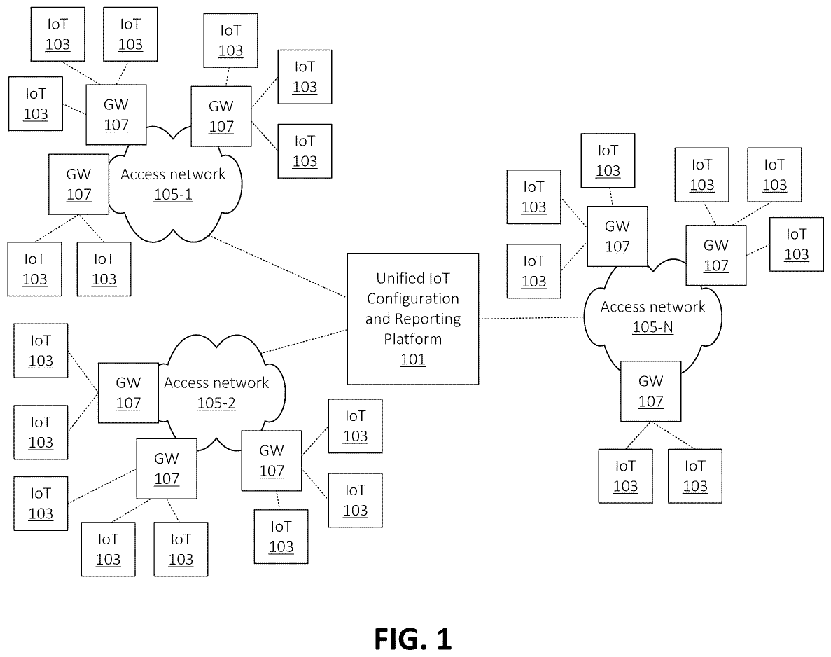

As shown in FIG. 1, UICRP 101 of some embodiments may be communicatively coupled to a variety of different IoT devices 103 (represented in the figures as, for example, “IoT 103”). IoT devices 103 may include or may be communicatively coupled to devices such as sensors, smart home appliances, alarms, and/or other types of devices. In one example, a particular IoT device 103 may include a temperature sensor that measures temperature (e.g., ambient air temperature at a location in which IoT device 103 is installed). In another example, IoT device 103 may include a water sensor that detects the presence of liquid (e.g., which may be used in applications such as plumbing leak detection in a smart home environment). In another example, IoT device 103 may include a humidity sensor that determines a measure of relative humidity of ambient air. In yet another example, IoT device 103 may include a home security sensor, such as a glass break sensor, a door or window opening sensor, a motion sensor, or the like. In another example, IoT device 103 may include an air particulate and/or gas sensor, such as a smoke detector, a carbon monoxide detector, an air quality sensor, or the like. As another example, IoT devices 103 may include Heating, Ventilation, and Air Conditioning (“HVAC”) sensors, such as HVAC airflow sensors, HVAC control board diagnostic sensors, or the like. In some embodiments, IoT devices 103 may include relatively complex sensors used in industrial environments such as electric current sensors, voltage monitoring sensors, liquid level monitoring through ultrasonic sensors, or other industrial sensors. In some embodiments, IoT devices 103 may include vibration sensors, pressure sensors, accelerometers, tracking devices, and/or other suitable types of sensors.

IoT devices 103 may generate and output monitoring information and/or other suitable types of information (referred to herein as “uplink information”). For example, a temperature sensor may periodically (e.g., every minute, every 15 minutes, hourly, daily, etc.) output a temperature reading, such as a current temperature, an average temperature over a given timeframe, a maximum temperature over a given timeframe, etc. As another example, the temperature sensor may output alerts (e.g., non-scheduled alerts, or “push” alerts) based on detecting the occurrence of particular conditions, such as a temperate rising greater than or falling lower than a given threshold temperature.

In some embodiments, IoT devices 103 and UICRP 101 may implement one or more application programming interfaces (“APIs”), software development kits (“SDKs”), frameworks, applications, etc. via which IoT devices 103 and UICRP 101 are configured to communicate with each other (e.g., using particular Internet Protocol (“IP”) discovery techniques or other suitable techniques). For example, IoT device 103 may implement a “client-side” application or API, where UICRP 101 may implement a “server-side” application or API. As another example, IoT devices 103 may be configured to communicate with some other device or system (e.g., an application server, a third-party IoT management platform, or the like), where such other device or system is configured to communicate with UICRP 101. Thus while examples described herein are provided in the context of communications between IoT devices 103 and UICRP 101 (e.g., via respective gateways 107), similar concepts may apply in environments where one or more other devices or systems are involved in communications between IoT devices 103 and UICRP 101.

In some embodiments, IoT devices 103 may output uplink information to UICRP 101 via one or more networks or devices, as discussed herein. For example, communication pathways between UICRP 101 and various IoT devices 103 may include or traverse one or more networks or devices, such as access networks 105 (e.g., access networks 105-1, 105-2, and 105-N) and/or one or more gateways 107. Access networks 105 may be implemented using various different connectivity technologies in order to wirelessly connect to respective IoT devices 103, including wireless technologies such as LoRaWAN, BLE, Wi-Fi, or the like. As another example, access networks 105 may be implemented using wired technologies such as IO-Link, Ethernet, Universal Serial Bus (“USB”), or the like. In general, IoT devices 103 may include circuitry and/or logic to communicate with gateways 107 (e.g., using short-range wireless communication technologies and/or wired technologies such as LoRaWAN, BLE, or IO-Link), but may lack circuitry and/or logic to communicate via longer range networks (e.g., using longer range wireless communication technologies such as LTE or 5G). On the other hand, access networks 105 may implement communication technologies to communicate with IoT devices 103 (e.g., via relatively short-range wireless communications such as BLE, LoRaWAN, or Wi-Fi, and/or via wired connections), and may further implement communication technologies to communicate with UICRP 101 via one or more other networks. In some embodiments, one gateway 107 may implement one access network 105. In some embodiments, multiple gateways 107 may implement a given access network 105 (e.g., gateways 107 may implement a “mesh” deployment or other suitable type of deployment).

In this manner, UICRP 101 may be able to communicate with IoT devices 103 and gateways 107 that implement a variety of different communication technologies. As such, embodiments described herein facilitate configuration and reporting operations of IoT devices 103 in a manner that is agnostic as to (e.g., not dependent on) which communication technologies are implemented by IoT devices 103 and gateways 107, thus ultimately reducing the complexity of deploying, managing, and configuring IoT devices 103 and gateways 107.

In some embodiments, UICRP 101 may include APIs (e.g., external-facing APIs) to enable communication with other platforms or devices. For example, such APIs may be used to communicate with applications executing in data centers associated with cloud service providers, which may provide services such as data storage, compute scaling, authentication management, etc. In some embodiments, such APIs may also permit users of UICRP 101 to interact with UICRP 101 according to the examples provided herein (e.g., via a web-based user interface, via user equipment hosted applications, using language-model interfaces, programmatically, etc.).

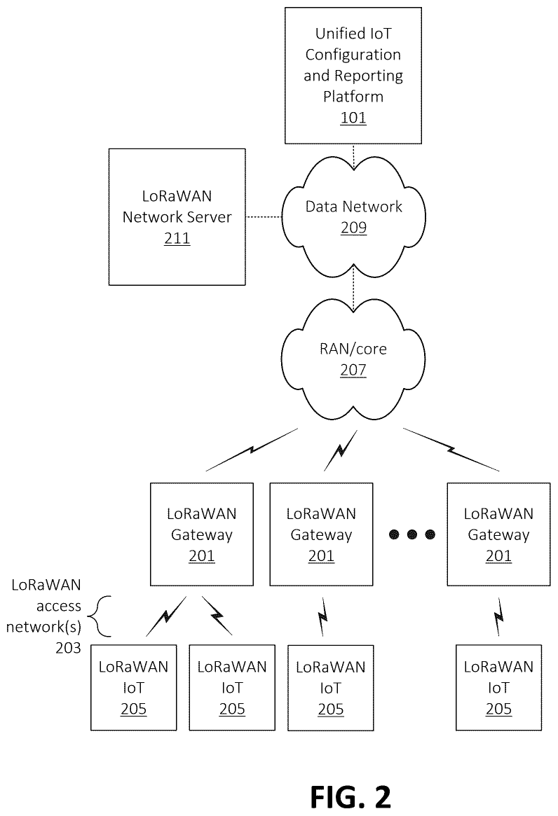

FIGS. 2-4 illustrate examples of different access networks 105 (e.g., which may be associated with different communication technologies) and corresponding gateways 107. For example, as discussed below, one or more gateways 107 may be or may include LoRaWAN gateways, BLE gateways, IO-Link gateways, and/or other types of gateways (e.g., that provide connectivity between respective IoT devices 103 and one or more other devices or networks). Additionally, as discussed below, one or more IoT devices 103 may be or may include LoRaWAN IoT devices, BLE IoT devices, IO-Link IoT devices, and/or other types of IoT devices (e.g., IoT devices that implement other types of communication technologies to communicate with respective gateways 107).

As shown in FIG. 2, for example, a set of LoRaWAN gateways 201 may implement one or more access networks 105 (e.g., one or more LoRaWAN access networks 203). LoRaWAN access networks 203 may operate according to a particular set of frequencies, bands, radio access technologies (“RATs”), etc. corresponding to one or more LoRaWAN standards. In some implementations, LoRaWAN access networks 203 may operate according to a sub-Gigahertz (“GHz”) band such as a 868 Megahertz (“MHz”) band, a 902-928 MHz band, a 915-928 MHz band, and/or some other suitable band. For example, LoRaWAN gateways 201 may include a first set of wireless hardware circuitry (e.g., antennas, transceivers, radios, or the like) that operates according to the particular set of frequencies, bands, RATs, etc. corresponding to one or more LoRaWAN standards.

A given LoRaWAN gateway 201 may communicate with one or more LoRaWAN IoT devices 205 via LoRaWAN access network 203. For example, LoRaWAN IoT devices 205 may operate according to the same particular set of frequencies, bands, RATs, etc. as implemented by LoRaWAN gateway 201 (e.g., corresponding to one or more particular LoRaWAN standards). In one embodiment, a particular LoRaWAN IoT device 205 may be considered as a particular IoT device 103 that further includes wireless hardware circuitry that operates according to the above-mentioned frequencies, bands, RATs, etc. For example, LoRaWAN gateway 201 may include a temperature sensor that monitors ambient air temperature, and outputs uplink information such as periodic and/or conditional reports and/or alerts via LoRaWAN access network 203 (e.g., via LoRaWAN gateway 201).

LoRaWAN gateway 201 may further include a second set of wireless hardware circuitry that operates according to another set of frequencies, bands, RATs, etc. For example, LoRaWAN gateway 201 may include wireless hardware circuitry that operates according to a Long-Term Evolution (“LTE”) RAT, a Fifth Generation (“5G”) RAT, and/or some other type of RAT (e.g., a licensed RAT that operates according to frequencies that have been licensed by a governmental or other authoritative entity). LoRaWAN gateway 201 may communicate with a wireless network (e.g., which may include, may implement, or may be implemented by a RAN and/or a core network (e.g., RAN/core network 207). RAN/core network 207 may include, for example, wireless network infrastructure equipment such as base stations (e.g., evolved Node Bs (“eNBs”), Next Generation Node Bs (“gNBs”), or the like) that operate according to an LTE RAT, a 5G RAT, etc. In this manner, RAN/core network 207 may provide broader or wider range coverage (e.g., nationwide coverage or international coverage) than is provided via LoRaWAN access network 203. Accordingly, LoRaWAN IoT devices 205 may not have the need for more complex or costly radios or other wireless hardware that would be needed to communicate with RAN/core network 207.

RAN/core network 207 may provide routing services, such as routing traffic between LoRaWAN gateways 201 and one or more other networks, such as Data Network (“DN”) 209. In one example, DN 209 may include or may be communicatively coupled to a Wide Area Network (“WAN”), such as the Internet. LoRaWAN gateways 201 may communicate (e.g., via RAN/core network 207 and/or DN 209) with LoRaWAN Network Server 211. LoRaWAN Network Server 211 may perform functions such as administrative or configuration functions with respect to one or more LoRaWAN gateways 201. As one example, LoRaWAN Network Server 211 may provide “wake up” or listening interval configuration information to one or more LoRaWAN gateways 201, which may specify a manner in which a given LoRaWAN gateway 201 implements LoRaWAN access network 203. For example, LoRaWAN gateway 201 may remain in a low power or sleep mode for a given duration (sometimes referred to as a “sleep interval”), and may enter a high power or wake mode for another duration (sometimes referred to as a “wake interval”). Scheduling sleep and wake intervals may serve as an avenue of power consumption reduction, both from the standpoint of LoRaWAN gateways 201 (e.g., which may potentially have finite power sources such as batteries) as well as LoRaWAN IoT devices 205 which may also have potentially finite power sources. Additionally, scheduling sleep and wake intervals may serve as an avenue of reducing noise or interference in a LoRaWAN band, as LoRaWAN bands may be unlicensed bands that are potentially subject to uncontrolled traffic.

As another example, LoRaWAN Network Server 211 may serve as an interface for an administrator or operator associated with a given LoRaWAN gateway 201 or set of LoRaWAN gateways 201. LoRaWAN Network Server 211 may assist with functions such as access control (e.g., allowing certain LoRaWAN IoT devices 205 to register with or connect to a given LoRaWAN access network 203 implemented by a given LoRaWAN gateway 201), Quality of Service (“QoS”) management, power consumption management, and/or other suitable functions. In this sense, multiple LoRaWAN gateways 201 associated with the same owner or operator may be deployed in diverse geographical regions (e.g., in multiple cities, states, provinces, etc.), and may be managed via LoRaWAN Network Server 211. In some embodiments, LoRaWAN Network Server 211 may provide traffic aggregation and/or routing services. For example, LoRaWAN Network Server 211 may receive uplink information from LoRaWAN IoT devices 205 via LoRaWAN gateways 201, RAN/core network 207, and DN 209, and may forward some or all of such traffic to UICRP 101 and/or some other suitable device or system (e.g., via DN 209). In accordance with some embodiments, LoRaWAN Network Server 211 may receive downlink information (e.g., configuration instructions, alert thresholds, reporting intervals, etc.) from UICRP 101 (e.g., via DN 209), which is directed to one or more particular LoRaWAN IoT devices 205. LoRaWAN Network Server 211 may route such traffic to its indicated LoRaWAN IoT device 205 (e.g., via an associated LoRaWAN gateway 201), and LoRaWAN gateway 201 may provide such information to LoRaWAN IoT device 205 in accordance with one or more LoRaWAN techniques. For example, LoRaWAN gateway 201 may schedule a transmission (e.g., a transmission burst) of the information to LoRaWAN IoT device 205 during a wake duration associated with LoRaWAN gateway 201 and/or LoRaWAN IoT device 205.

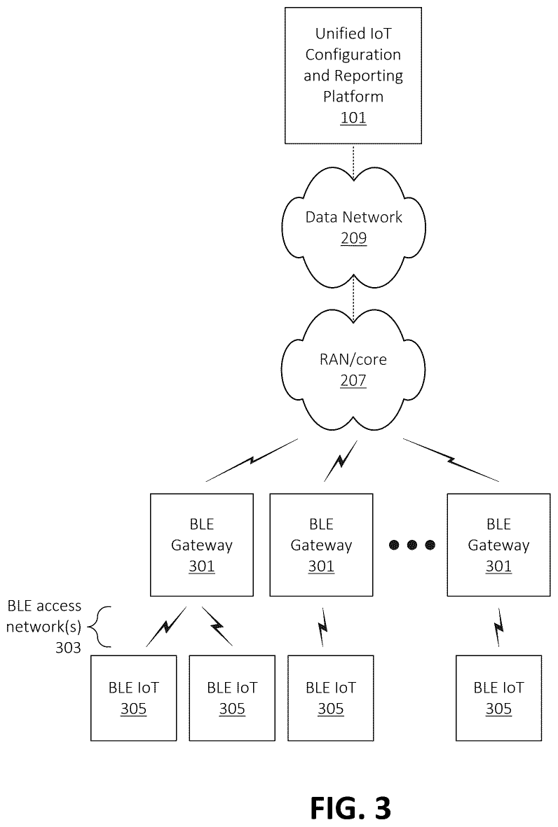

FIG. 3 illustrates another example deployment of particular IoT devices 103 and/or gateways 107. For example, a set of BLE gateways 301 may implement one or more access networks 105 (e.g., one or more BLE access networks 303). BLE access networks 303 may operate according to a particular set of frequencies, bands, RATs, etc. corresponding to one or more BLE standards. In some implementations, BLE access networks 303 may operate according to a 2.4 GHz band and/or some other suitable band. For example, BLE gateways 301 may include a first set of wireless hardware circuitry (e.g., antennas, transceivers, radios, or the like) that operates according to the particular set of frequencies, bands, RATs, etc. corresponding to one or more BLE standards.

A given BLE gateway 301 may communicate with one or more BLE IoT devices 305 via BLE access network 303. For example, BLE IoT devices 305 may operate according to the same particular set of frequencies, bands, RATs, etc. as implemented by BLE gateway 301 (e.g., corresponding to one or more particular BLE standards). In one embodiment, a particular BLE IoT device 305 may be considered as a particular IoT device 103 that further includes wireless hardware circuitry that operates according to the above-mentioned frequencies, bands, RATs, etc. For example, BLE gateway 301 may include a temperature sensor that monitors ambient air temperature, and outputs uplink information such as periodic and/or conditional reports and/or alerts via BLE access network 303 (e.g., via BLE gateway 301).

BLE gateway 301 may further include a second set of wireless hardware circuitry that operates according to another set of frequencies, bands, RATs, etc. For example, BLE gateway 301 may include wireless hardware circuitry that operates according to an LTE RAT, a 5G RAT, and/or some other type of RAT (e.g., a licensed RAT that operates according to frequencies that have been licensed by a governmental or other authoritative entity). BLE gateway 301 may communicate with a wireless network (e.g., which may include, may implement, or may be implemented by a RAN and/or a core network (e.g., RAN/core network 207). As discussed above, RAN/core network 207 may include wireless network infrastructure equipment such as base stations (e.g., eNBs, gNBs, or the like) that operate according to an LTE RAT, a 5G RAT, etc. In this manner, RAN/core network 207 may provide broader or wider range coverage (e.g., nationwide coverage or international coverage) than is provided via BLE access network 303. Accordingly, BLE IoT devices 305 may not have the need for more complex or costly radios or other wireless hardware that would be needed to communicate with RAN/core network 207. As discussed above, RAN/core network 207 may provide routing services, such as routing traffic between BLE gateways 301 and one or more other networks, such as DN 209. In one example, DN 209 may include or may be communicatively coupled to a WAN, such as the Internet.

BLE gateways 301 may be associated with configurable parameters such as power consumption parameters. The power consumption parameters may include “wake up” or listening interval configuration information, which may specify a manner in which a given BLE gateway 301 implements BLE access network 303. For example, BLE gateway 301 may remain in a low power or sleep mode for a given duration (sometimes referred to as a “sleep interval”), and may enter a high power or wake mode for another duration (sometimes referred to as a “wake interval”). Scheduling sleep and wake intervals may serve as an avenue of power consumption reduction, both from the standpoint of BLE gateways 301 (e.g., which may potentially have finite power sources such as batteries) as well as BLE IoT devices 305 which may also have potentially finite power sources. Additionally, scheduling sleep and wake intervals may serve as an avenue of reducing noise or interference in a BLE band, as BLE bands may be unlicensed bands that are potentially subject to uncontrolled traffic.

BLE gateways 301 may further be associated with one or more other types of configurable parameters. In one example, other such configurable parameters include specifying particular devices or device groups (e.g., based on hardware identifiers, Media Access Control (“MAC”) addresses, etc.) that are authorized to access a given BLE gateway 301, device attributes (e.g., manufacturer, vendor, model, device type, sensor type, etc.) of BLE IoT devices 305 that are authorized to access a given BLE gateway 301, quantity of BLE IoT devices 305 to scan per scanning window, duration of a scanning window, received signal strength thresholds for signals received from BLE IoT devices 305, and/or other types of parameters.

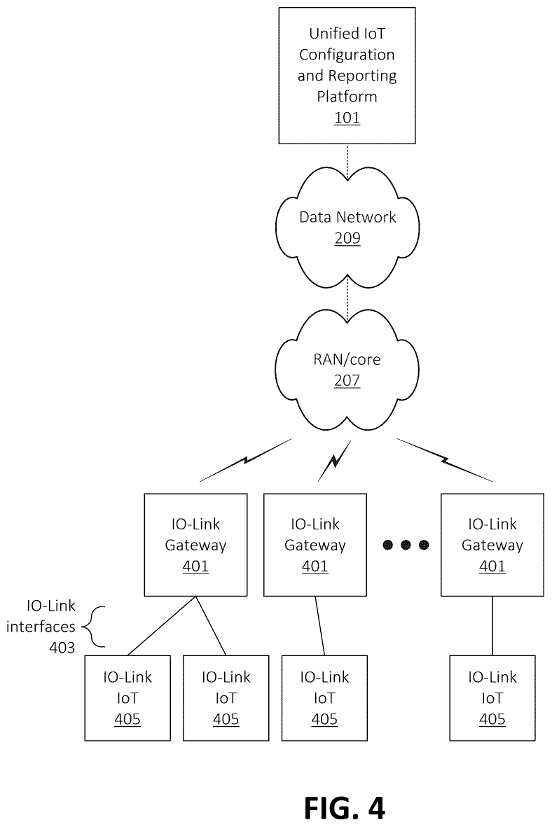

FIG. 4 illustrates another example deployment of particular IoT devices 103 and/or gateways 107. For example, a set of IO-Link gateways 401 may implement one or more IO-Link interfaces 403 (e.g., which may represent or may be represented by one or more access networks 105 in FIG. 1 ). For example, IO-Link gateways 401 and/or IO-Link IoT devices 405 may include one or more ports or other types of interfaces (e.g., physical interfaces) which may be connected to each other via one or more wires, cables, etc. In some embodiments, such wires, cables, etc. may include M12 connectors or adapters, such as 4-pin M12 connectors, 8-pin M12 connectors, M12-to-RJ45 adapters, M12-to-USB adapters, etc.

In one embodiment, a particular IO-Link IoT device 405 may be considered as a particular IoT device 103 that further includes communication circuitry and/or other suitable hardware (e.g., ports, interfaces, jacks, etc.), such as wired communication circuitry and/or other suitable hardware. For example, IO-Link gateway 401 may include a temperature sensor that monitors ambient air temperature, and outputs uplink information such as periodic and/or conditional reports and/or alerts via UI-Link interface 403 (e.g., via IO-Link gateway 401).

IO-Link gateway 401 may further include a set of wireless hardware circuitry that operates according to another set of frequencies, bands, RATs, etc. For example, IO-Link gateway 401 may include wireless hardware circuitry that operates according to an LTE RAT, a 5G RAT, and/or some other type of RAT (e.g., a licensed RAT that operates according to frequencies that have been licensed by a governmental or other authoritative entity). IO-Link gateway 401 may communicate with a wireless network (e.g., which may include, may implement, or may be implemented by a RAN and/or a core network (e.g., RAN/core network 207). As discussed above, RAN/core network 207 may include wireless network infrastructure equipment such as base stations (e.g., eNBs, gNBs, or the like) that operate according to an LTE RAT, a 5G RAT, etc. In this manner, RAN/core network 207 may provide broader or wider range coverage (e.g., nationwide coverage or international coverage) than is provided via UI-Link interface 403. Accordingly, IO-Link IoT devices 405 may not have the need for more complex or costly radios or any type of wireless hardware that would be needed to communicate with RAN/core network 207. As discussed above, RAN/core network 207 may provide routing services, such as routing traffic between IO-Link gateways 401 and one or more other networks, such as DN 209. In one example, DN 209 may include or may be communicatively coupled to a WAN, such as the Internet.

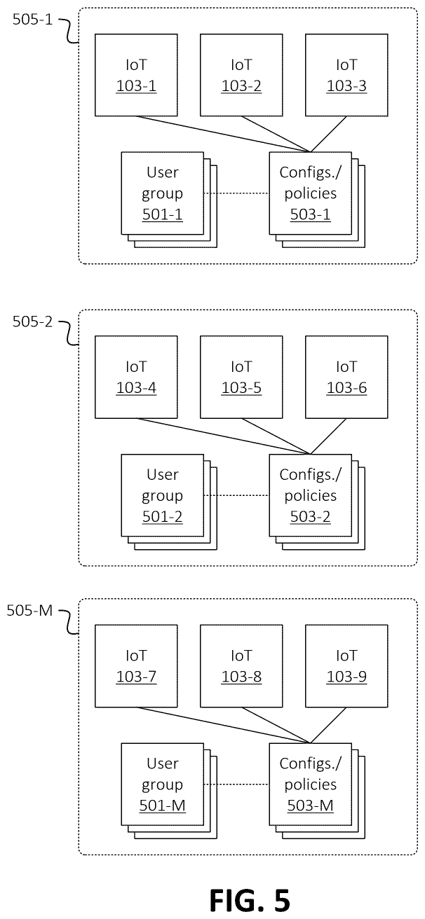

As discussed above, different IoT devices 103 may be associated with different owners, operators, or other such entities. For example, a particular organization may deploy, manage, etc. a particular set of IoT devices 103 for use by one or more user groups, such as employees, customers, vendors, partner entities, etc. As shown in FIG. 5, for example, a first set of IoT devices 103 (e.g., IoT devices 103-1, 103-2, and 103-3) may be associated with a first user group 501-1, a second set of IoT devices 103 (e.g., IoT devices 103-4, 103-5, and 103-6) may be associated with a second user group 501-2, a third set of IoT devices 103 (e.g., IoT devices 103-7, 103-8, and 103-9) may be associated with a third user group 501-M, and so on. Respective sets of IoT devices 103 with their associated user groups 501, along with configurations and/or policies associated with user groups 501 and/or corresponding IoT devices 103, may be represented as domains 505. For example, domain 505-1 may be associated with or may include user group 501-1 and their associated IoT devices 103 and configurations and/or policies 503-1, domain 505-2 may be associated with or may include user group 501-2 and their associated IoT devices 103 and configurations and/or policies 503-2, and domain 505-M may be associated with or may include user group 501-M and their associated IoT devices 103 and configurations and/or policies 503-M.

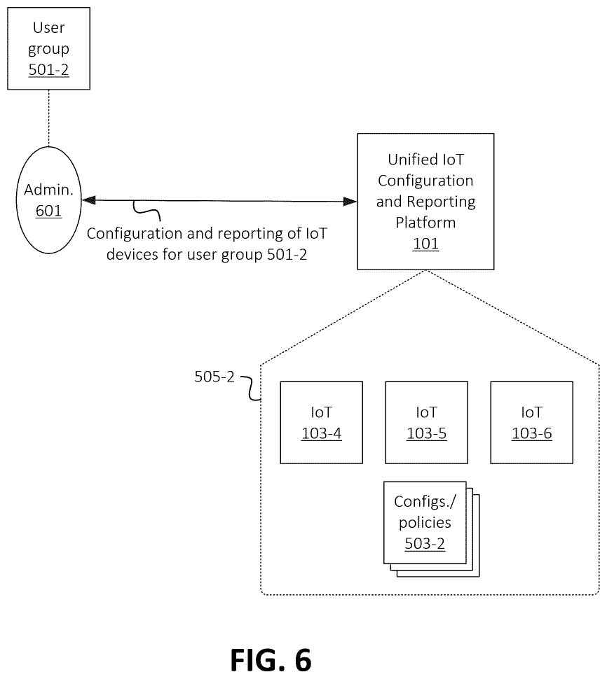

An administrator, operator, and/or other such entity associated with each respective user group 501 may, for example, register their respective IoT devices 103 with UICRP 101, which may include providing device identifiers, IP addresses, MAC addresses, serial numbers or other unique hardware device identifiers, Extended Unique Identifiers (“EUIs”), Device Unique Identifiers (“DevEUIs”), vendor identifiers, and/or other suitable communication or identification information associated with respective IoT devices 103 to UICRP 101. For example, as shown in FIG. 6, administrator 601, associated with user group 501-2 (e.g., domain 505-2) may configure, register, manage, etc. IoT devices 103 associated with domain 505-2 (e.g., IoT devices 103-4, 103-5, and 103-6). For example, administrator 601 may utilize an administrator console, a workstation, and/or other suitable type of device that is communicatively coupled to UICRP 101 (e.g., via one or more APIs, SDKs, or other suitable communication pathways). Administrator 601 may, for example, provide device identifiers, IP addresses, MAC addresses, or other suitable communication or identification information associated with IoT devices 103-4, 103-5, and 103-6. In some embodiments, administrator 601 may additionally provide communication information, authentication information, authorization information, identification information, and/or other suitable information associated with one or more users or devices associated with user group 501-2, such as user names, authentication tokens, certificates, or other such information.

Administrator 601 may also provide configurations and/or policies 503-2 to UICRP 101. In some embodiments, configurations and/or policies 503 (e.g., configurations and/or policies 503-2) may include access control policies (e.g., user and/or device identifiers (e.g., IP addresses, device identifiers, etc.) of users and/or devices that are authorized to receive uplink information from IoT devices 103 of domain 505-2 and/or that are authorized to provide downlink information to IoT devices 103 of domain 505-2. As another example, configurations and/or policies 503 may include alerting policies, monitoring policies, reporting policies, and/or one or more other policies for one or more IoT devices 103 of domain 505-2. For example, configurations and/or policies 503 may specify a particular reporting interval (e.g., output a sensor reading every 15 minutes) for IoT device 103-4, a particular alert threshold (e.g., output a sensor reading or alert when a particular monitored value crosses or reaches a threshold value), power consumption parameters (e.g., wake and/or sleep intervals), and/or other suitable configuration information.

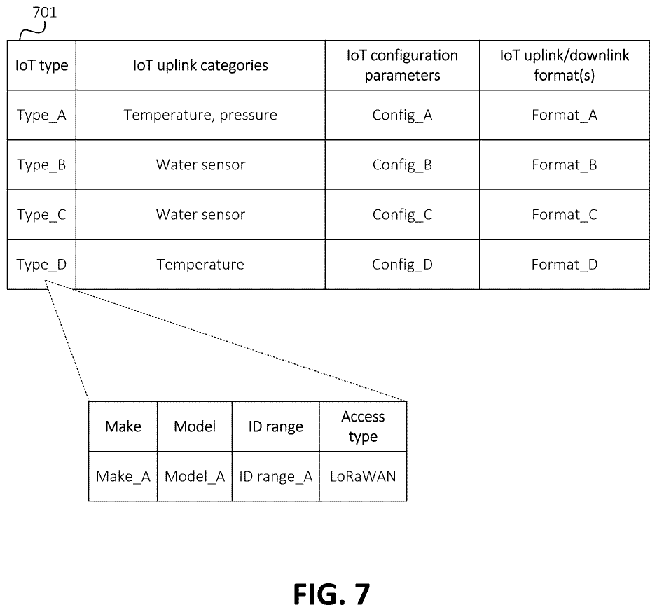

In order to provide a unified interface and point of access for users accessing IoT devices 103, UICRP 101 may maintain information associating each IoT device 103 with a set of parameters that can be used to aggregate and normalize disparate types and/or formats of uplink information from different types of IoT devices 103. FIG. 7 illustrates example data structure 701, which may be generated, maintained, and/or used by UICRP 101 to provide a unified interface and point of access for multiple IoT devices 103. In some embodiments, data structure 701 may be generated or refined using artificial intelligence/machine learning (“AI/ML”) techniques or other model-based and/or automated techniques.

As shown, data structure 701 includes information such as characteristics, attributes, etc. associated with different types of IoT devices 103. In this example, different IoT device types are represented with the labels “Type_A,” “Type_B,” “Type_C,” and “Type_D.” A different IoT device type, as referred to herein, may represent differentiating characteristics such as manufacturer (e.g., make) and/or model information, hardware capabilities such as types (e.g., temperature, motion, accelerometer, etc.) and/or quantities of sensors, version or revision information (e.g., version or revision of hardware or firmware), device identifier (e.g., MAC address or range of MAC addresses, serial number or range of serial numbers, EUI or range of EUIs, DevEUI or range of DevEUIs, etc.), access technology information (e.g., LoRaWAN, BLE, IO-Link, etc.), or other characteristics.

Data structure 701 may include, for each type of IoT device 103, IoT uplink and/or downlink formatting information (represented as “Format_A” for Type_A, “Format_B” for Type_B, and so on). IoT uplink formatting information may include mapping information, models, translation information, and/or other information which may be used to convert or extract uplink information received from a given IoT device 103 to a standard, unified format. Additionally, the IoT downlink formatting information may include mapping information, models, translation information, and/or other information which may be used to convert or extract downlink information, to send to a given IoT device 103, to a device-specific format which may be different from the standard, unified format. For example, the IoT uplink and/or downlink format information may be based on APIs or protocols used by particular types of IoT devices 103 (e.g., Message Queuing Telemetry Transport (“MQTT”) protocol or some other protocol), variables or data types used by particular types of IoT devices 103 (e.g., a decimal value representing a temperature, a binary value indicating operational status, a string value representing location information, and/or other variables or data types), or the like. In some embodiments, IoT uplink and/or downlink format information may include message formatting or syntactical information used by particular types of IoT devices 103, such as an indication of function calls and/or associated parameters that may be invoked by particular types of IoT devices 103, conditional logic or policies used by IoT devices 103 to determine whether to perform certain operations, comparators such as greater than or less than, delineation or tokenization information that specifies how to parse messages to or from particular types of IoT devices 103, or other such information.

In this manner, UICRP 101 may use IoT uplink and/or downlink formatting information to parse or “interpret” uplink messages from particular IoT devices 103 and/or downlink messages directed to particular IoT devices 103. The uplink and/or downlink formatting information and/or other information may be used to identify IoT uplink categories and/or IoT configuration parameters associated with a given type of IoT device 103. For example, based on a particular IoT uplink and/or downlink format (e.g., Format_A associated with a Type_A IoT device 103, UICRP 101 may identify that uplink information from this type of IoT device 103 includes temperature sensor information and pressure sensor information (e.g., that such IoT device 103 includes one or more temperature sensors and/or one or more pressure sensors).

In one example, a standard, unified format may be defined for a given type of sensor. For example, UICRP 101 may maintain or use a first format to represent uplink data associated with temperature sensors, a second format to represent uplink data associated with pressure sensors, a third format to represent uplink data associated with water sensors, and so on. For example, while different temperature sensors may utilize different uplink formats (e.g., different quantities of decimals in temperature readings, different temperature scales such as Fahrenheit or Celsius, different messaging protocols or message formats, etc.), the unified format may be normalized such that it is not necessary for a user device accessing the sensor information from multiple different temperature sensors to be able to parse, interpret, etc. different types of uplink message formats from different temperature sensors.

Similarly, data structure 701 may include IoT configuration parameters for each type of IoT device 103. For example, different types of IoT device 103 may have different parameters that can be configured, such as reporting interval, sensitivity, alert thresholds, or the like. As discussed above, instructions (e.g., downlink messages) to implement certain parameters by different types of IoT devices 103 may be associated with different protocols, APIs, syntax, or the like (e.g., different types of IoT devices 103 may interpret or parse messages or instructions differently). The IoT configuration parameters (e.g., Config_A for Type_A IoT devices 103) may include normalized or unified parameters, such that from a user perspective (e.g., a user accessing UICRP 101 to configuration Type_A IoT devices 103), each different IoT device 103 of Type_A is able to be configured in a similar manner, even if the actual instructions or messaging formats to different IoT devices 103 of the same type differ. In this manner, a user may be able to obtain a homogenous user experience both for uplink information (e.g., IoT monitoring and/or alert information) and downlink information (e.g., IoT configuration parameters), even for IoT devices 103 that utilize different uplink and/or downlink formatting parameters.

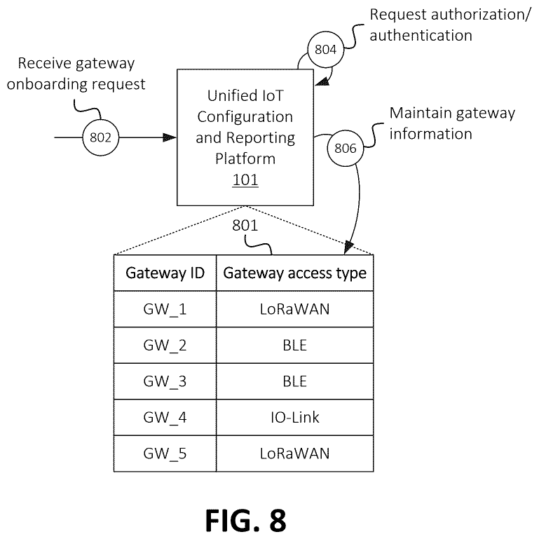

As shown in FIG. 8, UICRP 101 may also maintain information associated with different gateways 107. For example, different respective gateways 107 (e.g., LoRaWAN gateways 201, BLE gateways 301, and/or IO-Link Gateways 401) may be onboarded to or registered with UICRP 101 based on one or more onboarding requests (at 802). For example, an administrator, operator, etc. associated with one or more gateways 107 may output an onboarding request via an API, a web portal, an application, and/or some other suitable communication pathway with UICRP 101. In one example embodiment, UICRP 101 may present a graphical user interface (“GUI”), a web portal, or the like, which may be accessed via a workstation, an administrator console, or some other type of device. As another example, UICRP 101 may be communicatively coupled to an IoT management system or a user-facing IoT platform (e.g., via an API), where the IoT management system or user-facing IoT platform serves as an interface between UICRP 101 and one or more user devices.

In some embodiments, the gateway onboarding request (at 802) may include identifying information associated with a particular IoT gateway 107, such as a serial number, a device identifier, a MAC identifier, or some other suitable identifier. In some embodiments, the gateway onboarding request may include network credentials and/or wireless hardware identifier information of IoT gateway 107, such as an International Mobile Station Equipment Identity (“IMEI”), an International Mobile Subscriber Identity (“IMSI”), a Subscription Permanent Identifier (“SUPI”), a Globally Unique Temporary Identifier (“GUTI”), or the like. In some embodiments, the onboarding request may specify a type of access technology used by IoT gateway 107 to communicate with IoT devices 103, such as LoRaWAN, BLE, IO-Link, etc.

In some embodiments, UICRP 101 may authenticate (at 804) and/or verify the request. For example, UICRP 101 may determine whether the request is from an authorized source. For example, the requestor (e.g., an administrator, owner, etc. onboarding a given gateway 107) may have previously registered with UICRP 101, which may include establishing authentication credentials, establishing authorization policies, etc., whereby such entity is able to be authenticated and verified by UICRP 101.

Assuming UICRP 101 authenticates and verifies authorization for the request, UICRP 101 may maintain (at 806) information regarding one or more registered IoT gateways 107. UICRP 101 may, for instance, maintain data structure 801 or some other suitable similar information that includes information regarding one or more gateways 107. For example, for each gateway identifier or range of identifiers (e.g., MAC addresses, ranges of MAC addresses, IMEI values, ranges of IMEI values, etc.), data structure 801 may include information indicating a gateway access type. In some embodiments, data structure 801 may include additional or different types of information, such as a location of IoT gateway 107 (e.g., latitude and longitude coordinates, a cell or coverage area of a wireless network, a Tracking Area (“TA”) of a wireless network, a physical address, and/or some other designation of a geographical location). As discussed below, UICRP 101 may utilize such information in order to configure an IoT gateway 107 (e.g., LoRaWAN gateway 201 or BLE gateway 301) to implement configuration parameters for a respective IoT device 103 (e.g., LoRaWAN IoT device 205 or BLE IoT device 305), such as monitoring, alerting, and/or reporting interval parameters received via a unified IoT control interface of some embodiments. The unified IoT control interface may include multiple different display screens, user interfaces (“UIs”), modalities, or the like.

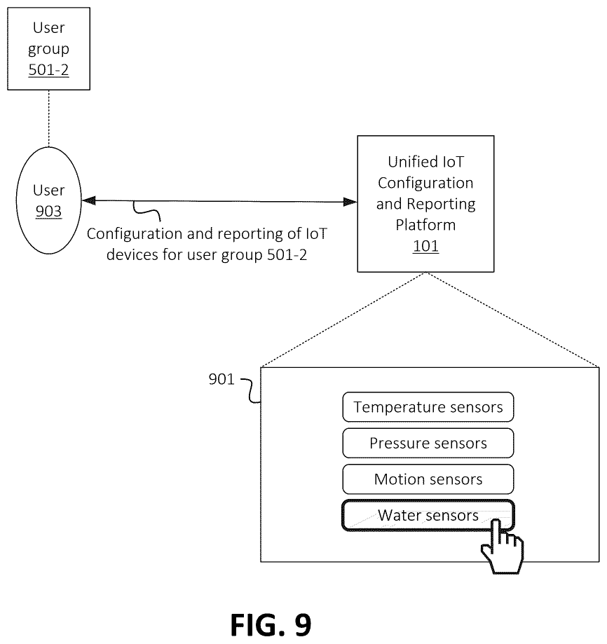

For example, as shown in FIG. 9, UICRP 101 may, in the course of providing configuration and reporting services for IoT devices 103 associated with a particular domain 505 (e.g., domain 505-2, which is associated with user group 501-2), present UI 901 to user 903 associated with user group 501-2. User 903 may access UICRP 101 via, for example, a web portal, an application, etc. provided by UICRP 101. In some embodiments, user 903 may access a user device, such as a workstation, an administrator console, a computer, or the like, which may communicate with UICRP 101 via an API, an SDK, or some other suitable communication pathway. Thus, in some implementations, UICRP 101 may present UI 901 to user 903 via the user device (e.g., the user device may present UI 901 and/or other UIs, windows, display screens, etc. associated with a unified IoT control interface of some embodiments, based on instructions, commands, or other information provided by UICRP 101).

In this example, UI 901 may indicate different categories of IoT devices 103 that are accessible to user 903 and/or other users of user group 501-2. For example, user group 501-2 may have authorization to access relatively numerous quantities of IoT devices 103, where such IoT devices 103 fall into categories such as “temperature sensors,” “pressure sensors,” “motion sensors,” and “water sensors.” In practice, UI 901 may include additional, fewer, or different types of IoT devices 103 that are able to be accessed by user 903. In some embodiments, the information presented via UI 901 and/or one or more other UIs discussed herein may be based on, for example, IoT device information such as the information shown in data structure 701 in FIG. 7 (e.g., where IoT device types are associated with particular IoT uplink categories and/or IoT configuration parameters).

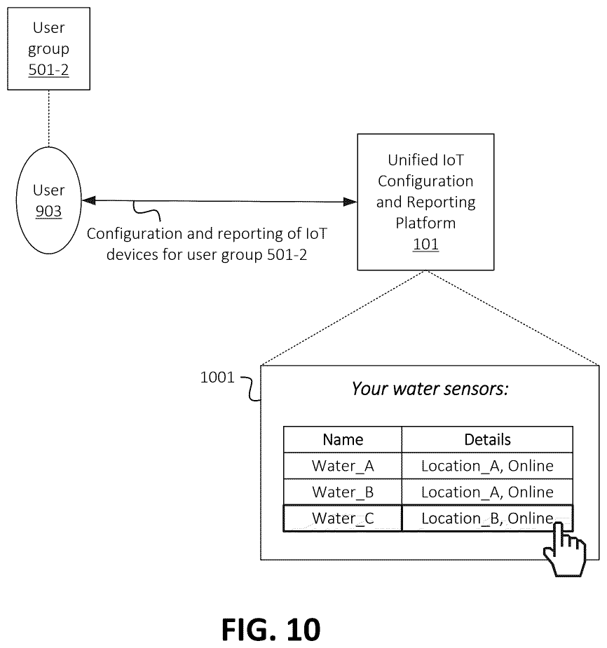

In this example, assume that user 903 selects an option to access (e.g., view, configure, etc.) IoT devices 103 associated with the “water sensors” category, such as by selecting a button or other element in UI 901 associated with the “water sensors” category. As shown in FIG. 10, UICRP 101 may present UI 1001, in order to provide user 903 with additional details or options for IoT devices 103, accessible by user group 501-2, that are associated with the “water sensors” category. For example, UI 1001 may present device identifiers (e.g., names, MAC addresses, IP addresses, and/or other suitable identifiers) of respective IoT devices 103 associated with the “water sensors” category, and/or other details regarding such IoT devices 103. In one example, such details may include location information (e.g., a set of latitude and longitude coordinates, Global Positioning System (“GPS”) coordinates, a building or facility name, or the like).

In some embodiments, device details for a particular IoT device 103 may include operational status information, such as “online,” “offline,” “not responding,” “congested,” “delayed response,” or the like. In some embodiments, device details may include additional or different information, such as performance information (e.g., latency, throughput, etc.), congestion or load information (e.g., processor and/or network load information), and/or other suitable information. In some embodiments, device details may include alert or threshold information, such as information indicating whether a particular IoT device 103 has measured or detected values that exceed one or more thresholds (e.g., an excessive temperature, an electrical fault, an excessive number of vibrations, or the like). In this manner, user 903 may have the ability to quickly and easily (e.g., “at a glance”) ascertain information, including operational status information, alert and/or monitoring information, location information, and/or other information for multiple different IoT devices 103, including IoT devices 103 from different manufacturers, and/or that utilize different access technologies. The unified IoT control interface may provide this “at a glance” functionality without requiring user 903 to manually access each individual IoT device 103, or to even be “aware” of the particular communication pathways via which individual IoT devices 103 are accessible.

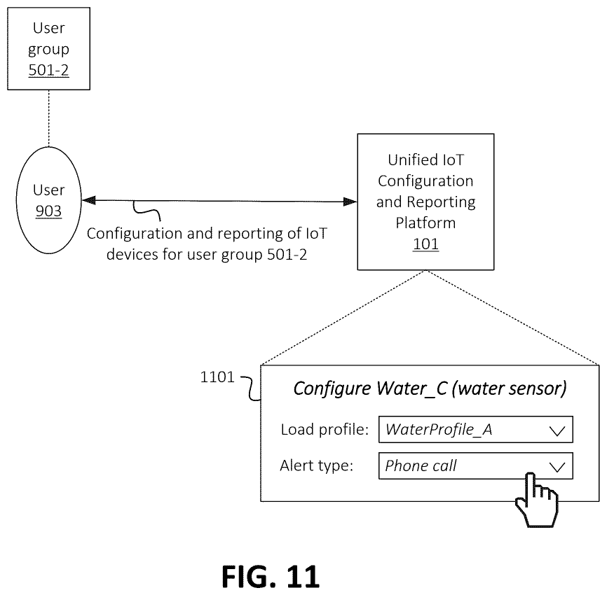

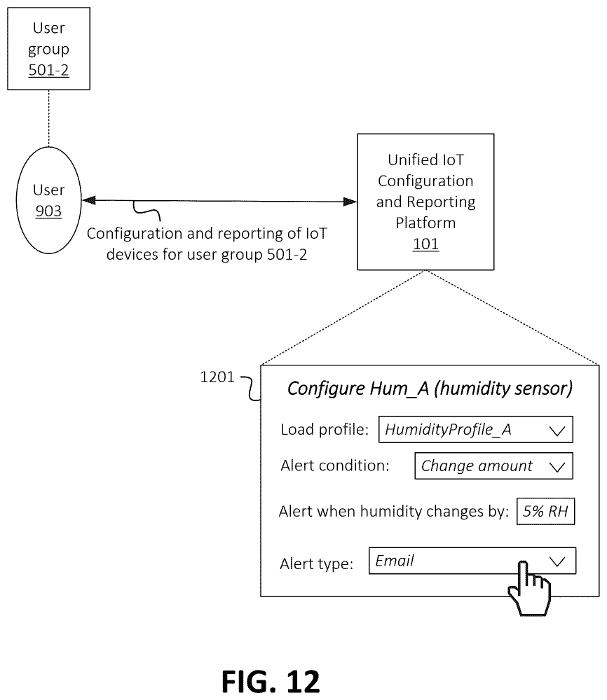

Further assume that user 903 selects a particular IoT device 103 (e.g., IoT device 103 with the name “Water_C”), such as by selecting a button or other selectable option in UI 1001. As shown in FIG. 11, UICRP 101 may present UI 1101, which includes options to configure the particular IoT device 103. In some embodiments, different types or categories of IoT devices 103 may be associated with different configuration options. For example, UI 1101 includes configuration options for a “water sensor” IoT device category, while UI 1201 of FIG. 12 includes configuration options for a “humidity sensor” IoT device category. Configuration UIs, such as UIs 1101 and 1201, may include configuration options such as alert thresholds, alert types, monitoring intervals, or other types of configuration options.

In some embodiments, different types of IoT devices 103 may be associated with different configuration profiles or sets of configuration profiles, where a particular configuration profile (also referred to simply as “profile”) may include a particular set of configuration parameters. For example, profiles may be specified such that they can be quickly selected and applied to different IoT devices 103 of a given IoT device type or category. For example, in FIG. 11, a particular profile for a “water sensor” IoT device type may be selected (e.g., “WaterProfile_A”). In some embodiments, selecting a particular profile may populate or overwrite one or more configuration parameters shown in UI 1101. In some embodiments, selecting a particular profile may populate or set one or more other configuration parameters (e.g., in addition to what is shown in UI 1101). In this example, for example, user 903 may select (e.g., in addition to selecting WaterProfile_A) an alert type, such as a phone call, when the particular IoT device 103 (e.g., the water sensor referred to as “Water_C”) detects water.

In some embodiments, UICRP 101 may present (e.g., via 1101 or some other UI) additional alerting options, such as escalation options. For example, as discussed below, an escalation option may include different types or intervals of alerts in the event that a given IoT device 103 outputs an alert that is not responded to or acted on by one or more users associated with such IoT device 103 (e.g., users in a respective user group 501 associated with IoT device 103). In some embodiments, in addition to, or in lieu of presenting an option to select a particular profile (e.g., select a particular water sensor profile out of a set of candidate water sensor profiles), UI 1101 may include some or all configurable parameters associated with a “water sensor” IoT device category.

UI 1201, in FIG. 12, may present different configuration parameters, based on being associated with a different IoT device category (e.g., a “humidity sensor” category). For example, similar to how user 903 may select a particular water sensor IoT device to view UI 1101 (which includes configuration parameters for water sensors), user 903 may select a particular humidity sensor to view UI 1201. Thus, although the actions of selecting different IoT devices 103 may be similar (e.g., clicking on a button or other UI element representing a particular IoT device 103), the resulting UIs presented by UICRP 101 may be different (e.g., may be in accordance with a particular IoT device type that was selected). In the example of FIG. 12, UI 1201 includes configuration parameters that are specific to humidity sensors, such as options for outputting alerts when relative humidity (“RH”), as measured by a given humidity sensor, changes by at least 5% (e.g., within a relatively short time, such as within one hour, and/or where the change is measured irrespective of time). In other examples, user 903 may select other alert conditions, such as when RH crosses a certain threshold (e.g., 55% RH, 60% RH, or the like, irrespective of an amount by which the RH has changed). In this example, user 903 may select to receive email alerts when the humidity sensor detects a change of at least 5% RH.

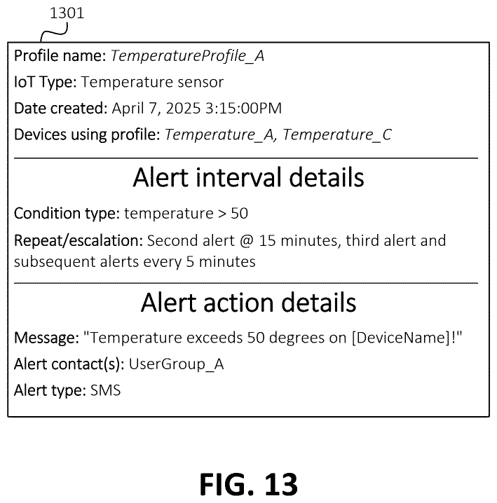

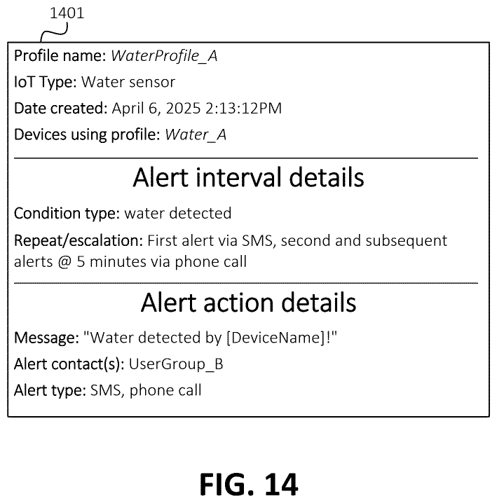

FIGS. 13 and 14 illustrate example UIs that may be used to present or to modify one or more profiles associated with different IoT device categories. For example, UI 1301 of FIG. 13 may be associated with a profile for a “temperature sensor” IoT device category, while UI 1401 of FIG. 14 may be associated with a profile for a “water sensor” IoT device category. In practice, other UIs or arrangements may be used to present profile information for profiles associated with respective IoT device categories. Additionally, similar concepts may apply for other types of IoT device categories.

As shown in FIG. 13, for example, UI 1301 may indicate information such as a profile name and an IoT device category applicable to a particular profile. UI 1301 may also indicate particular IoT devices 103 for which the profile has been selected (e.g., IoT devices 103 for which particular alerting parameters, monitoring parameters, or other parameters have been applied). As noted above, the IoT devices 103 indicated in UI 1301 may be limited to those that are associated with a particular domain 505 and/or user group 501, in order to maintain privacy, security, and separation of different domains 505.

Some or all of the configuration parameters for a given IoT device 103 may be based on IoT uplink and/or downlink formats associated with a given IoT device type (e.g., as shown in data structure 701 of FIG. 7). For example, configuration parameters relating to the manner in which alerts are provided, the manner in which alerts are detected (e.g., based on one or more thresholds), parameters or values which may be monitored by a given IoT device 103, etc. may be specified by or otherwise derived from one or more uplink and/or downlink formats associated with the given IoT device 103. Uplink formats may, for example, specify types of information monitored or provided by a given IoT device 103, such as temperature readings, water detection readings, or the like. Further, as discussed above, uplink formats may specify units of measure associated with such readings, a measure of precision (e.g., whether temperature is accurate to one degree, to 0.1 degrees, etc.), or the like. Additionally, as discussed above, downlink formats may specify types of commands, instructions, parameters, etc. that can be provided to a given IoT device 103 in order to configure such IoT device 103 (e.g., to configure an interval at which IoT device 103 monitors or reports information, configuration thresholds based on which IoT device 103 outputs alerts, etc.). In this manner, when presenting a UI that allows for the configuration of IoT device 103 (e.g., UIs 1101, 1201, 1301, 1401, etc.), UICRP 101 may identify types of configuration parameters that are relevant to IoT device 103, and may accordingly present such configuration parameters (e.g., to user 903).

For example, UI 1301 may include configurable parameters for a particular IoT device 103 (e.g., a “temperature sensor” IoT device type), such as alert intervals, alert actions, and/or alert severity. In some embodiments, configurable parameters may be used in implementing various functionalities, such as an emergency push button sensor alert, where such parameters specify that a given user or user group will always be notified. As discussed below, escalation parameters for such alerts may be configurable as well, to help ensure that a user takes an action to remedy the emergency situation.

In some embodiments, UI 1301 may reflect a “report” style UI, which provides information to user 903 regarding a given set of configurable parameters (e.g., a particular profile) for a “temperature sensor” IoT device type. In some embodiments, UI 1301 may include one or more options for user 903 to modify some or all of the configurable parameters for IoT device 103.

The alert interval for IoT device 103 may specify, for example, conditions based on which alerts are detected or are to be outputted by IoT device 103. For example, the alert interval parameters shown in UI 1301 may specify that an alert is detected when a temperature exceeding 50 degrees is detected at IoT device 103. The example alert interval parameters for IoT device 103 shown in FIG. 13 may further include escalation options, such as modifying an alert interval if the alert condition continues to be detected. In this manner, user 903 may be alerted more quickly or urgently in situations where such user 903 may not have received an initial alert. For example, the escalation conditions may specify that a second alert should be sent after 15 minutes of the alert condition continuing, and that a third and subsequent alerts should be sent every 5 minutes until the alert condition is no longer met.

UI 1301 may further indicate (or allow user 903 to specify) actions or other parameters associated with the alerts, such as a message to provide with the alerts (e.g., “Temperature exceeds 50 degrees on [DeviceName]!”, where “DeviceName” may be replaced with a name or other identifier of the particular IoT device 103 for which the alert condition was detected. The alert action details may further allow for specifying one or more users or devices to contact, such as a maintenance or repair department, an owner and/or operator of IoT device 103, some or all of the users of a given user group 501, and/or one or more other individuals. In some embodiments, the alert action details may specify an alert type, such as Short Message Service (“SMS”), phone call, email, or the like.

UI 1401, shown in FIG. 14, may include different configurable parameters for a different IoT device type. In this example, the alert condition may be a different type than the example of FIG. 13. For example, the IoT device type for UI 1401 may be a “water sensor” type, and the alert condition may be a “water detected” alert condition type. Additionally, in some embodiments, the escalation option may include multiple different modes of contact for subsequent alerts. For example, as shown, a first alert may be sent via SMS, and a second and subsequent alerts may be sent via a phone call or other suitable communication technique.

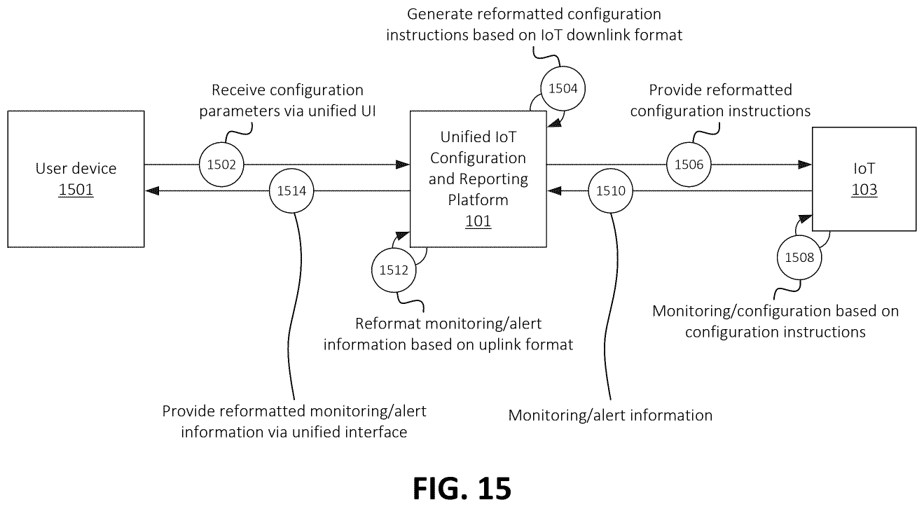

FIG. 15 illustrates an example of configuring a particular IoT device 103 based on configuration parameters received via the unified IoT control interface of some embodiments. UICRP 101 may, for example, receive (at 1502) configuration parameters for IoT device 103, which may include or may be based on user selections received via one or more UIs presented by or associated with UICRP 101, such as example UIs 901, 1001, 1101, 1201, 1301, and/or 1401. For example, a user may select one or more selectable elements presented by a particular user device 1501 that presents the unified IoT control interface (e.g., one or more UIs, as discussed above) in order to specify configuration parameters for a given IoT device 103.

UICRP 101 may generate (at 1504) reformatted configuration instructions based on the received configuration parameters. The reformatted configuration instructions may, in some embodiments, be based on a particular IoT downlink format for IoT device 103. For example, as discussed above with respect to data structure 701, UICRP 101 may identify a downlink format associated with IoT device 103, which may include formats, protocols, APIs, etc. implemented by IoT device 103. In environments where multiple different IoT device types are deployed, a variety of different formats, protocols, APIs, etc. may be implemented by the different IoT device types.

Generating (at 1504) the reformatted configuration instructions may include converting, mapping, translating, recomposing, altering, or other operations with respect to the configuration parameters received from user device 1501. For example, such converting, mapping, translating, recomposing, altering, etc. may be based on downlink format information (e.g., as discussed above with respect to data structure 701) for a particular IoT device type of IoT device 103. In this manner, for example, configuration parameters for different IoT devices 103 with the same uplink category (e.g., water sensor monitoring or alert information, temperature sensor monitoring or alert information, etc.) may be received in a format associated with the unified IoT control interface of some embodiments, and may be converted into respective downlink formats for the different IoT devices 103. As such, maintaining, deploying, and/or providing the unified IoT control interface may be simplified, inasmuch as an entity that maintains, deploys, and/or provides the unified IoT control interface may be able to do so using a single format (or set of formats), API (or set of APIs), single protocol (or set of protocols), and so forth.

UICRP 101 may provide (at 1506) the reformatted configuration instructions to IoT device 103 (e.g., via a particular gateway 107 to which IoT device 103 is connected). IoT device 103 may perform (at 1508) one or more operations based on the configuration instructions, such as configuring a monitoring interval (e.g., an interval at which IoT device 103 should perform a monitoring operation, a sensing operation, a detection operation, or the like). Additionally, or alternatively, the one or more operations (at 1508) may include configuring a reporting interval (e.g., an interval at which IoT device 103 should output a report or alert, a user group or user device group that should receive reports or alerts, a manner in which reports or alerts should be delivered such as SMS or telephone call, or the like). Additionally, or alternatively, the one or more operations (at 1508) may include one or more other types of configuration operations, such as configuring energy saving or power consumption parameters, updating system settings, or other configuration operations.

After implementing (at 1508) the configuration instructions, IoT device 103 may proceed to operate based on such configuration instructions. For example, IoT device 103 may perform a monitoring or sensing operation according to a particular monitoring interval and/or may output alerts or monitoring reports according to a particular reporting interval. For example, IoT device 103 may output one or more alerts or monitoring reports to user device 1501. In another example implementation, IoT device 103 may output the alerts or monitoring reports to user device 1501, such as directly to user device 1501 and/or via some other device, system, or network. For example, IoT device 103 may communicate with (e.g., provide reports or alerts to) user device 1501 via an application executed by user device 1501, via a Mobile Directory Number (“MDN”) associated with user device 1501, via a messaging application or server, or the like.

Additionally, or alternatively, IoT device 103 may output at output (at 1510) alerts or monitoring reports to UICRP 101. In some embodiments, UICRP 101 may reformat (at 1512) the alerts or monitoring reports from an uplink format, API, protocol, etc. (e.g., as implemented by IoT device 103) to a unified format, API, protocol, etc. implemented by UICRP 101. For example, UICRP 101 may utilize uplink format information associated with IoT device 103 (e.g., as discussed above with respect to data structure 701) to identify or generate monitoring information such as operational status information, location information, present sensor information, or the like via the unified IoT control interface of some embodiments (e.g., via one or more UIs). UICRP 101 may provide (at 1514) the reformatted monitoring and/or alert information via a unified IoT control interface, such as one or more UIs as discussed above. For example, UICRP 101 may provide operational status information associated with IoT device 103, an alert and/or monitoring history associated with IoT device 103, and/or other information associated with IoT device 103 (e.g., based on monitoring and/or alert information provided by IoT device 103 and/or other IoT devices 103).

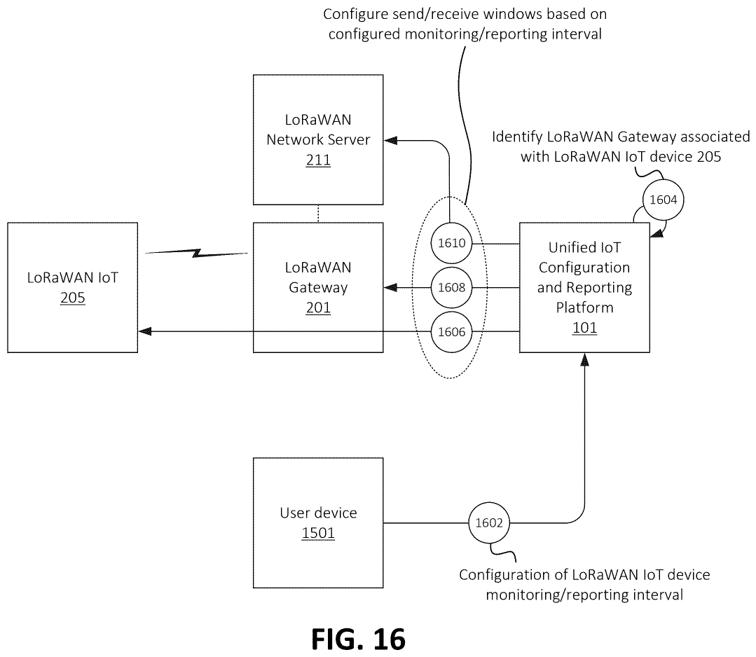

In some embodiments, UICRP 101 may configure one or more other devices or systems based on configuration parameters received via the unified IoT control interface. For example, as shown in FIG. 16, assume that UICRP 101 receives (at 1602) configuration parameters for a particular LoRaWAN IoT device 205, such as monitoring and/or reporting interval parameters. As noted above, devices in a LoRaWAN deployment, such as LoRaWAN IoT devices 205 and LoRaWAN gateways 201, may operate based on scheduled wake and/or sleep intervals, such that LoRaWAN IoT devices 205 and LoRaWAN gateways 201 may implement overlapping wake intervals during which LoRaWAN IoT devices 205 and LoRaWAN gateways 201 communicate. In accordance with some embodiments, when receiving wake and/or sleep interval configuration information for a particular LoRaWAN IoT device 205, UICRP 101 may additionally identify (at 1604) a particular LoRaWAN gateway 201, to which LoRaWAN IoT device 205 is connected, for which wake and/or sleep interval configuration information should potentially also be modified. Similarly, when receiving certain configuration parameters (e.g., reporting and/or monitoring interval parameters), UICRP 101 may identify that such configuration parameters may directly or indirectly affect wake and/or sleep intervals, such as a situation in which a modified reporting interval falls within a current sleep interval (e.g., a sleep or wake interval should be modified such that the modified reporting interval overlaps with a wake interval).

UICRP 101 may, in accordance some embodiments, configure (at 1606, 1608, and/or 1610) LoRaWAN IoT device 205 and/or one or more LoRaWAN infrastructure devices, such as LoRaWAN gateway 201 to which LoRaWAN IoT device 205 is connected and/or a particular LoRaWAN Network Server 211 associated with LoRaWAN gateway 201. For example, UICRP 101 may output (at 1606) configuration instructions, parameters, etc. to LoRaWAN IoT device 205 (e.g., by sending configuration instructions via LoRaWAN gateway 201). Additionally, or alternatively, UICRP 101 may output (at 1608) configuration instructions, parameters, etc. to LoRaWAN gateway 201. Additionally, or alternatively, UICRP 101 may output (at 1610) configuration instructions, parameters, etc. to LoRaWAN Network Server 211. In some embodiments, LoRaWAN Network Server 211 may further configure LoRaWAN gateway 201 based on configuration instructions, parameters, etc. received (e.g., (at 1610) by LoRaWAN Network Server 211.

Configuring (at 1606, 1608, and/or 1610) LoRaWAN IoT device 205, LoRaWAN gateway 201, and/or LoRaWAN Network Server 211 may include configuring such devices to implement modified sleep and/or wake intervals that are determined based on modified reporting and/or monitoring intervals for LoRaWAN IoT device 205, and/or otherwise providing an indication of the modified sleep and/or wake intervals. For example, UICRP 101 may indicate (at 1608 and/or 1610) the modified reporting and/or monitoring intervals for LoRaWAN IoT device 205 to LoRaWAN gateway 201 and/or LoRaWAN Network Server 211, and/or may indicate the modified sleep and/or wake intervals to LoRaWAN gateway 201 and/or LoRaWAN Network Server 211. In this manner, LoRaWAN gateway 201 may be configured to wake up and/or sleep in accordance with modified reporting and/or monitoring intervals for LoRaWAN IoT device 205 (e.g., to wake up in order to wirelessly, using a LoRaWAN communication technology, reporting and/or monitoring information from LoRaWAN IoT device 205), and to forward uplink information received during such wake intervals to UICRP 101, user device 1501, and/or some other suitable device or system.

In some embodiments, similar concepts may apply to other types of gateways 107, such as BLE gateways 301. For example, UICRP 101 may identify that a set of reporting and/or monitoring intervals are applicable to a particular BLE IoT device 305, and may identify a particular BLE gateway 301 that provides connectivity to such BLE IoT device 305. UICRP 101 may provide wake and/or sleep interval configuration information to BLE gateway 301, in order to modify one or more wake and/or sleep intervals, power saving configuration information, or the like associated with BLE gateway 301. For example, as similarly noted above, such configuration of BLE gateway 301 may ensure that BLE gateway 301 is in an “awake,” “active,” “listening,” etc. state when BLE IoT device 305 wirelessly outputs information (e.g., reporting and/or monitoring information) via a BLE communication technology.

In some embodiments, configuring gateways 107 (e.g., LoRaWAN gateway 201 and/or BLE gateway 301, as discussed above) may be performed without an explicit command or instruction from a user of user device 1501. For example, such user may not necessarily need to have knowledge or awareness of a particular LoRaWAN gateway 201 or BLE gateway 301 to which a particular LoRaWAN IoT device 205 or BLE IoT device 305 is connected, and may further not need to specifically output instructions to such LoRaWAN gateway 201 or BLE gateway 301 in order to ensure that LoRaWAN gateway 201 or BLE gateway 301 is able to communicate with LoRaWAN IoT device 205 or BLE IoT device 305 (e.g., is not sleeping, in an inactive or idle state, etc. when LoRaWAN IoT device 205 or BLE IoT device 305 are transmitting wireless signals with uplink information). In this manner, the user experience is simplified and enhanced for users seeking to modify configuration parameters for IoT devices 103 that implement particular wireless access technologies (e.g., access technologies where IoT devices 103 and/or gateways 107 implement wake and/or sleep intervals or other similar mechanics).

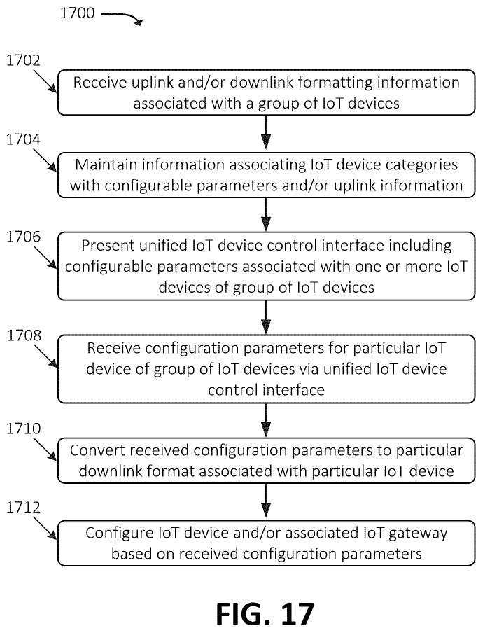

FIG. 17 illustrates an example process for 1700 providing and implementing a unified IoT control interface, in accordance with some embodiments. In some embodiments, some or all of process 1700 may be performed by UICRP 101.

As shown, process 1700 may include receiving (at 1702) uplink and/or downlink formatting information associated with a group of IoT devices 103. For example, as discussed above (e.g., with respect to data structure 701), UICRP 101 may receive or maintain uplink and/or downlink formatting information for one or more IoT devices 103, such as IoT devices 103 associated with one or more domains 505.

Process 1700 may further include maintaining (at 1704) information associating particular IoT device categories with particular configuration parameters and/or uplink information. For example, as discussed above, UICRP 101 may generate or maintain mapping information, translation information, or other suitable information that associates different sets of configuration parameters with different IoT device types. In some embodiments, UICRP 101 may also maintain information associating particular IoT devices 103 (e.g., particular IoT device 103 identifiers, such as serial numbers, device identifiers, MAC addresses, or the like) with particular IoT device types and/or sets of configuration parameters.

Process 1700 may additionally include presenting (at 1706) a unified IoT device control interface, which includes configurable parameters associated with one or more IoT devices 103 of a group of IoT devices 103 (e.g., associated with a given domain 505). For example, as discussed above, UICRP 101 may present one or more UIs to user device 1501, where such UIs may include options to modify configuration parameters of one or more different types of IoT devices 103, which may include IoT devices 103 of the same IoT device type or category, but with different access technologies, communication protocols, APIs, or the like.

Process 1700 may also include receiving (at 1708) configuration parameters for a particular IoT device 103 via the unified IoT device control interface. For example, as discussed above, a particular user 903 accessing user device 1501 may select one or more buttons, menu items, etc. to modify one or more configuration parameters of IoT device 103.

Process 1700 may further include converting (at 1710) the received configuration parameters to a particular downlink format associated with the particular IoT device 103. For example, as discussed above, UICRP 101 may utilize the downlink formatting information associated with IoT device 103 (e.g., as discussed above with respect to data structure 701) to generate configuration instructions in accordance with one or more APIs, communication protocols, formats, etc. implemented by IoT device 103. As discussed above, such conversion may render it unnecessary for user 903 or user device 1501 to implement such APIs, communication protocols, formats, etc. associated with IoT device 103 and/or other IoT devices 103.

Process 1700 may additionally include configuring (at 1712) IoT device 103 and/or an associated gateway 107 based on the received configuration parameters. For example, as discussed above, UICRP 101 may provide the configuration parameters, in accordance with one or more downlink formats (e.g., protocols, APIs, etc.) implemented by IoT device 103. In some embodiments, as discussed above, UICRP 101 may identify IoT devices 103 that implement particular access technologies, such as LoRaWAN or BLE, and may further configure gateways 107 (e.g., LoRaWAN gateways 201 and/or BLE gateways 301) based on the received configuration parameters. For example, as discussed above, UICRP 101 may automatically (e.g., without an explicit user instruction) configure wake intervals, sleep intervals, power save settings, etc. of LoRaWAN gateways 201 and/or BLE gateways 301 based on configuration parameters provided for LoRaWAN IoT devices 205 and/or BLE IoT devices 305 (e.g., in order to ensure that LoRaWAN gateways 201 and/or BLE gateways 301 are in a “receiving” or “listening” or “awake” mode when LoRaWAN IoT devices 205 and/or BLE IoT devices 305 wirelessly output uplink information, such as monitoring and/or alert information).

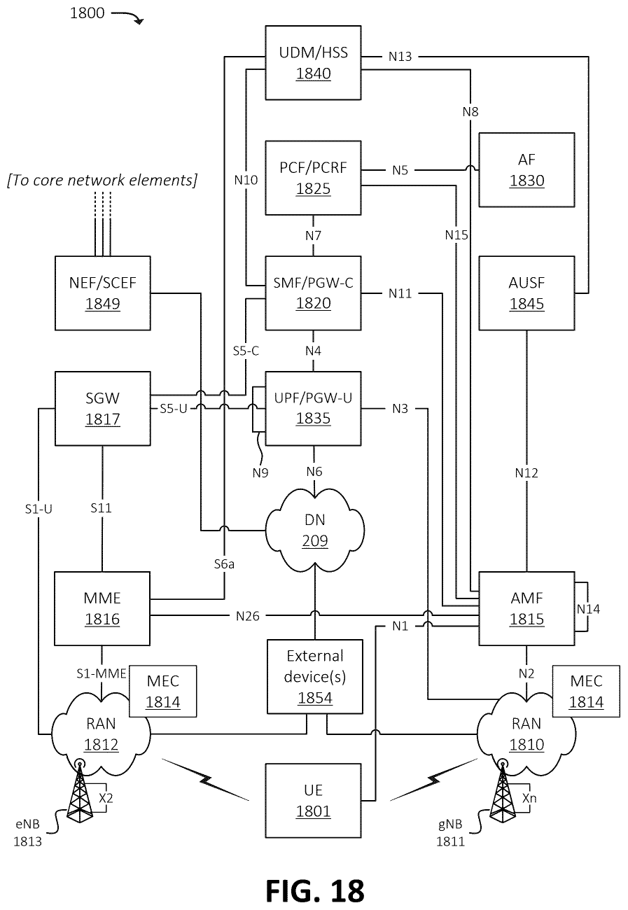

FIG. 18 illustrates an example environment 1800, in which one or more embodiments may be implemented. In some embodiments, environment 1800 may correspond to a 5G network, and/or may include elements of a 5G network. In some embodiments, environment 1800 may correspond to a 5G Non-Standalone (“NSA”) architecture, in which a 5G RAT may be used in conjunction with one or more other RATs (e.g., an LTE RAT), and/or in which elements of a 5G core network may be implemented by, may be communicatively coupled with, and/or may include elements of another type of core network (e.g., an evolved packet core (“EPC”)). In some embodiments, portions of environment 1800 may represent or may include a 5G core (“5GC”). As shown, environment 1800 may include UE 1801, RAN 1810 (which may include one or more Next Generation Node Bs (“gNBs”) 1811), RAN 1812 (which may include one or more evolved Node Bs (“eNBs”) 1813), and various network functions such as Access and Mobility Management Function (“AMF”) 1815, Mobility Management Entity (“MME”) 1816, Serving Gateway (“SGW”) 1817, Session Management Function (“SMF”)/Packet Data Network (“PDN”) Gateway (“PGW”)-Control plane function (“PGW-C”) 1820, Policy Control Function (“PCF”)/Policy Charging and Rules Function (“PCRF”) 1825, Application Function (“AF”) 1830, User Plane Function (“UPF”)/PGW-User plane function (“PGW-U”) 1835, Unified Data Management (“UDM”)/Home Subscriber Server (“HSS”) 1840, Authentication Server Function (“AUSF”) 1845, and Network Exposure Function (“NEF”)/Service Capability Exposure Function (“SCEF”) 1849. Environment 1800 may also include one or more networks, such as DN 209. Environment 1800 may include one or more additional devices or systems communicatively coupled to one or more networks (e.g., DN 209), such as one or more external devices 1854.

The example shown in FIG. 18 illustrates one instance of each network component or function (e.g., one instance of SMF/PGW-C 1820, PCF/PCRF 1825, UPF/PGW-U 1835, UDM/HSS 1840, and/or AUSF 1845). In practice, environment 1800 may include multiple instances of such components or functions. For example, in some embodiments, environment 1800 may include multiple “slices” of a core network, where each slice includes a discrete and/or logical set of network functions (e.g., one slice may include a first instance of AMF 1815, SMF/PGW-C 1820, PCF/PCRF 1825, and/or UPF/PGW-U 1835, while another slice may include a second instance of AMF 1815, SMF/PGW-C 1820, PCF/PCRF 1825, and/or UPF/PGW-U 1835). The different slices may provide differentiated levels of service, such as service in accordance with different Quality of Service (“QoS”) parameters.

The quantity of devices and/or networks, illustrated in FIG. 18, is provided for explanatory purposes only. In practice, environment 1800 may include additional devices and/or networks, fewer devices and/or networks, different devices and/or networks, or differently arranged devices and/or networks than illustrated in FIG. 18. For example, while not shown, environment 1800 may include devices that facilitate or enable communication between various components shown in environment 1800, such as routers, modems, gateways, switches, hubs, etc. In some implementations, one or more devices of environment 1800 may be physically integrated in, and/or may be physically attached to, one or more other devices of environment 1800. Alternatively, or additionally, one or more of the devices of environment 1800 may perform one or more network functions described as being performed by another one or more of the devices of environment 1800.

Additionally, one or more elements of environment 1800 may be implemented in a virtualized and/or containerized manner. For example, one or more of the elements of environment 1800 may be implemented by one or more Virtualized Network Functions (“VNFs”), Cloud-Native Network Functions (“CNFs”), etc. In such embodiments, environment 1800 may include, may implement, and/or may be communicatively coupled to an orchestration platform that provisions hardware resources, installs containers or applications, performs load balancing, and/or otherwise manages the deployment of such elements of environment 1800. In some embodiments, such orchestration and/or management of such elements of environment 1800 may be performed by, or in conjunction with, the open-source Kubernetes® application programming interface (“API”) or some other suitable virtualization, containerization, and/or orchestration system.

Elements of environment 1800 may interconnect with each other and/or other devices via wired connections, wireless connections, or a combination of wired and wireless connections. Examples of interfaces or communication pathways between the elements of environment 1800, as shown in FIG. 18, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 18, such as Service-Based Interfaces (“SBIs”), including an Namf interface, an Nudm interface, an Npcf interface, an Nupf interface, an Nnef interface, an Nsmf interface, and/or one or more other SBIs.

UE 1801 may include a computation and communication device, such as a wireless mobile communication device that is capable of communicating with RAN 1810, RAN 1812, and/or DN 209. UE 1801 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 1801 may send traffic to and/or receive traffic (e.g., user plane traffic) from DN 209 via RAN 1810, RAN 1812, and/or UPF/PGW-U 1835. In some embodiments, UE 1801 may be, may include, may be implemented by, and/or may be communicatively coupled to user device 1501. In some embodiments, UE 1801 may be, may include, may be implemented by, and/or may be communicatively coupled to one or more IoT gateways 107.

RAN 1810 may be, or may include, a 5G RAN that implements a 5G RAT and that includes one or more base stations (e.g., one or more gNBs 1811), via which UE 1801 may communicate with one or more other elements of environment 1800. UE 1801 may communicate with RAN 1810 via an air interface (e.g., as provided by gNB 1811). For instance, RAN 1810 may receive traffic (e.g., user plane traffic such as voice call traffic, data traffic, messaging traffic, etc.) from UE 1801 via the air interface, and may communicate the traffic to UPF/PGW-U 1835 and/or one or more other devices or networks. Further, RAN 1810 may receive signaling traffic, control plane traffic, etc. from UE 1801 via the air interface, and may communicate such signaling traffic, control plane traffic, etc. to AMF 1815 and/or one or more other devices or networks. Additionally, RAN 1810 may receive traffic intended for UE 1801 (e.g., from UPF/PGW-U 1835, AMF 1815, and/or one or more other devices or networks) and may communicate the traffic to UE 1801 via the air interface.

RAN 1812 may be, or may include, an LTE RAN that implements an LTE RAT and that includes one or more base stations (e.g., one or more eNBs 1813), via which UE 1801 may communicate with one or more other elements of environment 1800. UE 1801 may communicate with RAN 1812 via an air interface (e.g., as provided by eNB 1813). For instance, RAN 1812 may receive traffic (e.g., user plane traffic such as voice call traffic, data traffic, messaging traffic, signaling traffic, etc.) from UE 1801 via the air interface, and may communicate the traffic to UPF/PGW-U 1835 (e.g., via SGW 1817) and/or one or more other devices or networks. Further, RAN 1812 may receive signaling traffic, control plane traffic, etc. from UE 1801 via the air interface, and may communicate such signaling traffic, control plane traffic, etc. to MME 1816 and/or one or more other devices or networks. Additionally, RAN 1812 may receive traffic intended for UE 1801 (e.g., from UPF/PGW-U 1835, MME 1816, SGW 1817, and/or one or more other devices or networks) and may communicate the traffic to UE 1801 via the air interface.

One or more RANs of environment 1800 (e.g., RAN 1810 and/or RAN 1812) may include, may implement, and/or may otherwise be communicatively coupled to one or more edge computing devices, such as one or more Multi-Access/Mobile Edge Computing (“MEC”) devices (referred to sometimes herein simply as a “MECs”) 1814. MECs 1814 may be co-located with wireless network infrastructure equipment of RANs 1810 and/or 1812 (e.g., one or more gNBs 1811 and/or one or more eNBs 1813, respectively). Additionally, or alternatively, MECs 1814 may otherwise be associated with geographical regions (e.g., coverage areas) of wireless network infrastructure equipment of RANs 1810 and/or 1812. In some embodiments, one or more MECs 1814 may be implemented by the same set of hardware resources, the same set of devices, etc. that implement wireless network infrastructure equipment of RANs 1810 and/or 1812. In some embodiments, one or more MECs 1814 may be implemented by different hardware resources, a different set of devices, etc. from hardware resources or devices that implement wireless network infrastructure equipment of RANs 1810 and/or 1812. In some embodiments, MECs 1814 may be communicatively coupled to wireless network infrastructure equipment of RANs 1810 and/or 1812 (e.g., via a high-speed and/or low-latency link such as a physical wired interface, a high-speed and/or low-latency wireless interface, or some other suitable communication pathway).

MECs 1814 may include hardware resources (e.g., configurable or provisionable hardware resources) that may be configured to provide services and/or otherwise process traffic to and/or from UE 1801, via RAN 1810 and/or 1812. For example, RAN 1810 and/or 1812 may route some traffic from UE 1801 (e.g., traffic associated with one or more particular services, applications, application types, etc.) to a respective MEC 1814 instead of to core network elements of 1800 (e.g., UPF/PGW-U 1835). MEC 1814 may accordingly provide services to UE 1801 by processing such traffic, performing one or more computations based on the received traffic, and providing traffic to UE 1801 via RAN 1810 and/or 1812. MEC 1814 may include, and/or may implement, some or all of the functionality described above with respect to UPF/PGW-U 1835, AF 1830, one or more application servers, and/or one or more other devices, systems, VNFs, CNFs, etc. In this manner, ultra-low latency services may be provided to UE 1801, as traffic does not need to traverse links (e.g., backhaul links) between RAN 1810 and/or 1812 and the core network.

AMF 1815 may include one or more devices, systems, VNFs, CNFs, etc., that perform operations to register UE 1801 with the 5G network, to establish bearer channels associated with a session with UE 1801, to hand off UE 1801 from the 5G network to another network, to hand off UE 1801 from the other network to the 5G network, manage mobility of UE 1801 between RANs 1810 and/or gNBs 1811, and/or to perform other operations. In some embodiments, the 5G network may include multiple AMFs 1815, which communicate with each other via the N14 interface (denoted in FIG. 18 by the line marked “N14” originating and terminating at AMF 1815).

MME 1816 may include one or more devices, systems, VNFs, CNFs, etc., that perform operations to register UE 1801 with the EPC, to establish bearer channels associated with a session with UE 1801, to hand off UE 1801 from the EPC to another network, to hand off UE 1801 from another network to the EPC, manage mobility of UE 1801 between RANs 1812 and/or eNBs 1813, and/or to perform other operations.

SGW 1817 may include one or more devices, systems, VNFs, CNFs, etc., that aggregate traffic received from one or more eNBs 1813 and send the aggregated traffic to an external network or device via UPF/PGW-U 1835. Additionally, SGW 1817 may aggregate traffic received from one or more UPF/PGW-Us 1835 and may send the aggregated traffic to one or more eNBs 1813. SGW 1817 may operate as an anchor for the user plane during inter-eNB handovers and as an anchor for mobility between different telecommunication networks or RANs (e.g., RANs 1810 and 1812).

SMF/PGW-C 1820 may include one or more devices, systems, VNFs, CNFs, etc., that gather, process, store, and/or provide information in a manner described herein. SMF/PGW-C 1820 may, for example, facilitate the establishment of communication sessions on behalf of UE 1801. In some embodiments, the establishment of communications sessions may be performed in accordance with one or more policies provided by PCF/PCRF 1825.

PCF/PCRF 1825 may include one or more devices, systems, VNFs, CNFs, etc., that aggregate information to and from the 5G network and/or other sources. PCF/PCRF 1825 may receive information regarding policies and/or subscriptions from one or more sources, such as subscriber databases and/or from one or more users (such as, for example, an administrator associated with PCF/PCRF 1825).

AF 1830 may include one or more devices, systems, VNFs, CNFs, etc., that receive, store, and/or provide information that may be used in determining parameters (e.g., quality of service parameters, charging parameters, or the like) for certain applications.

UPF/PGW-U 1835 may include one or more devices, systems, VNFs, CNFs, etc., that receive, store, and/or provide data (e.g., user plane data). For example, UPF/PGW-U 1835 may receive user plane data (e.g., voice call traffic, data traffic, etc.), destined for UE 1801, from DN 209, and may forward the user plane data toward UE 1801 (e.g., via RAN 1810, SMF/PGW-C 1820, and/or one or more other devices). In some embodiments, multiple instances of UPF/PGW-U 1835 may be deployed (e.g., in different geographical locations), and the delivery of content to UE 1801 may be coordinated via the N9 interface (e.g., as denoted in FIG. 18 by the line marked “N9” originating and terminating at UPF/PGW-U 1835). Similarly, UPF/PGW-U 1835 may receive traffic from UE 1801 (e.g., via RAN 1810, RAN 1812, SMF/PGW-C 1820, and/or one or more other devices), and may forward the traffic toward DN 209. In some embodiments, UPF/PGW-U 1835 may communicate (e.g., via the N4 interface) with SMF/PGW-C 1820, regarding user plane data processed by UPF/PGW-U 1835.

UDM/HSS 1840 and AUSF 1845 may include one or more devices, systems, VNFs, CNFs, etc., that manage, update, and/or store, in one or more memory devices associated with AUSF 1845 and/or UDM/HSS 1840, profile information associated with a subscriber. In some embodiments, UDM/HSS 1840 may include, may implement, may be communicatively coupled to, and/or may otherwise be associated with some other type of repository or database, such as a Unified Data Repository (“UDR”). AUSF 1845 and/or UDM/HSS 1840 may perform authentication, authorization, and/or accounting operations associated with one or more UEs 1801 and/or one or more communication sessions associated with one or more UEs 1801.

DN 209 may include one or more wired and/or wireless networks. For example, DN 209 may include an Internet Protocol (“IP”)-based PDN, a wide area network (“WAN”) such as the Internet, a private enterprise network, and/or one or more other networks. UE 1801 may communicate, through DN 209, with data servers, other UEs 1801, and/or to other servers or applications that are coupled to DN 209. DN 209 may be connected to one or more other networks, such as a public switched telephone network (“PSTN”), a public land mobile network (“PLMN”), and/or another network. DN 209 may be connected to one or more devices, such as content providers, applications, web servers, and/or other devices, with which UE 1801 may communicate.

External devices 1854 may include one or more devices or systems that communicate with UE 1801 via DN 209 and one or more elements of 1800 (e.g., via UPF/PGW-U 1835). In some embodiments, external devices 1854 may include, may implement, and/or may otherwise be associated with UICRP 101, LoRaWAN Network Server 211, and/or some other external device or system. External devices 1454 may include, for example, one or more application servers, content provider systems, web servers, or the like. External devices 1854 may include, for example, one or more application servers, content provider systems, web servers, or the like. External devices 1854 may, for example, implement “server-side” applications that communicate with “client-side” applications executed by UE 1801. External devices 1854 may provide services to UE 1801 such as gaming services, videoconferencing services, messaging services, email services, web services, and/or other types of services. Operations described above with respect to a given external device 1854 (e.g., in accordance with some embodiments) may be performed by a single device, by a cloud computing system, by one or more devices that implement a virtualized or containerized environment, a collection of devices, etc.

In some embodiments, external devices 1854 may communicate with one or more elements of environment 1800 (e.g., core network elements) via NEF/SCEF 1849. NEF/SCEF 1849 include one or more devices, systems, VNFs, CNFs, etc. that provide access to information, APIs, and/or other operations or mechanisms of one or more core network elements to devices or systems that are external to the core network (e.g., to external device 1854 via DN 209). NEF/SCEF 1849 may maintain authorization and/or authentication information associated with such external devices or systems, such that NEF/SCEF 1849 is able to provide information, that is authorized to be provided, to the external devices or systems. For example, a given external device 1854 may request particular information associated with one or more core network elements. NEF/SCEF 1849 may authenticate the request and/or otherwise verify that external device 1854 is authorized to receive the information, and may request, obtain, or otherwise receive the information from the one or more core network elements. In some embodiments, NEF/SCEF 1849 may include, may implement, may be implemented by, may be communicatively coupled to, and/or may otherwise be associated with a Security Edge Protection Proxy (“SEPP”), which may perform some or all of the functions discussed above. External device 1854 may, in some situations, subscribe to particular types of requested information provided by the one or more core network elements, and the one or more core network elements may provide (e.g., “push”) the requested information to NEF/SCEF 1849 (e.g., in a periodic or otherwise ongoing basis).

In some embodiments, external devices 1854 may communicate with one or more elements of RAN 1810 and/or 1812 via an API or other suitable interface. For example, a given external device 1854 may provide instructions, requests, etc. to RAN 1810 and/or 1812 to provide one or more services via one or more respective MECs 1814. In some embodiments, such instructions, requests, etc. may include QoS parameters, Service Level Agreements (“SLAs”), etc. (e.g., maximum latency thresholds, minimum throughput thresholds, etc.) associated with the services.

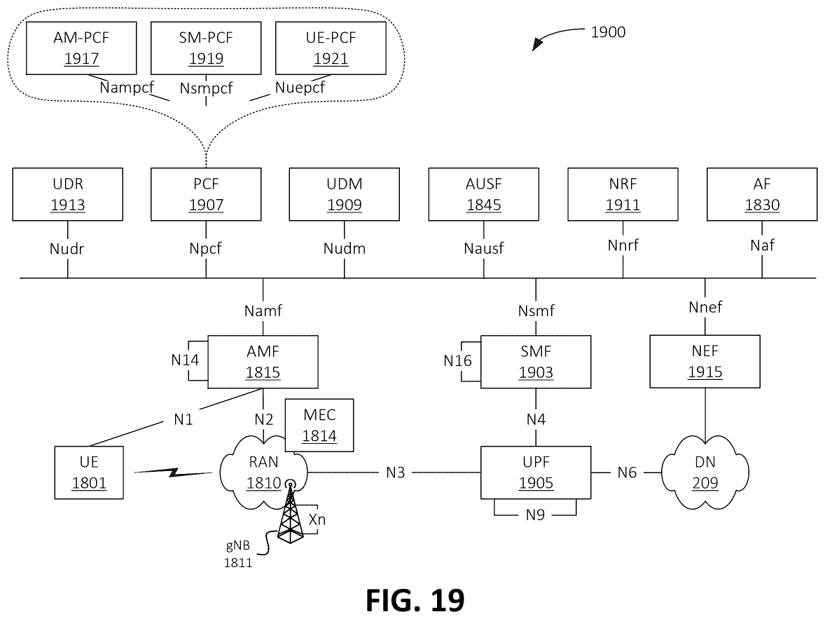

FIG. 19 illustrates another example environment 1900, in which one or more embodiments may be implemented. In some embodiments, environment 1900 may correspond to a 5G network, and/or may include elements of a 5G network. In some embodiments, environment 1900 may correspond to a 5G SA architecture. In some embodiments, environment 1900 may include a 5GC, in which 5GC network elements perform one or more operations described herein.

As shown, environment 1900 may include UE 1801, RAN 1810 (which may include one or more gNBs 1811 or other types of wireless network infrastructure) and various network functions, which may be implemented as VNFs, CNFs, etc. Such network functions may include AMF 1815, SMF 1903, UPF 1905, PCF 1907, UDM 1909, AUSF 1845, Network Repository Function (“NRF”) 1911, AF 1830, UDR 1913, and NEF 1915. Environment 1900 may also include or may be communicatively coupled to one or more networks, such as DN 209.

The example shown in FIG. 19 illustrates one instance of each network component or function (e.g., one instance of SMF 1903, UPF 1905, PCF 1907, UDM 1909, AUSF 1845, etc.). In practice, environment 1900 may include multiple instances of such components or functions. For example, in some embodiments, environment 1900 may include multiple “slices” of a core network, where each slice includes a discrete and/or logical set of network functions (e.g., one slice may include a first instance of SMF 1903, PCF 1907, UPF 1905, etc., while another slice may include a second instance of SMF 1903, PCF 1907, UPF 1905, etc.). Additionally, or alternatively, one or more of the network functions of environment 1900 may implement multiple network slices. The different slices may provide differentiated levels of service, such as service in accordance with different QoS parameters.

The quantity of devices and/or networks, illustrated in FIG. 19, is provided for explanatory purposes only. In practice, environment 1900 may include additional devices and/or networks, fewer devices and/or networks, different devices and/or networks, or differently arranged devices and/or networks than illustrated in FIG. 19. For example, while not shown, environment 1900 may include devices that facilitate or enable communication between various components shown in environment 1900, such as routers, modems, gateways, switches, hubs, etc. In some implementations, one or more devices of environment 1900 may be physically integrated in, and/or may be physically attached to, one or more other devices of environment 1900. Alternatively, or additionally, one or more of the devices of environment 1900 may perform one or more network functions described as being performed by another one or more of the devices of environment 1900.

Elements of environment 1900 may interconnect with each other and/or other devices via wired connections, wireless connections, or a combination of wired and wireless connections. Examples of interfaces or communication pathways between the elements of environment 1900, as shown in FIG. 19, may include interfaces shown in FIG. 19 and/or one or more interfaces not explicitly shown in FIG. 19. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 1900 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 1815), an Nudm interface (e.g., indicating communications to be routed to UDM 1909), an Npcf interface, an Nupf interface, an Nnef interface, an Nsmf interface, an Nnrf interface, an Nudr interface, an Naf interface, and/or one or more other SBIs.

UPF 1905 may include one or more devices, systems, VNFs, CNFs, etc., that receive, route, process, and/or forward traffic (e.g., user plane traffic). As discussed above, UPF 1905 may communicate with UE 1801 via one or more communication sessions, such as PDU sessions. Such PDU sessions may be associated with a particular network slice or other suitable QoS parameters, as noted above. UPF 1905 may receive downlink user plane traffic (e.g., voice call traffic, data traffic, etc. destined for UE 1801) from DN 209, and may forward the downlink user plane traffic toward UE 1801 (e.g., via RAN 1810). In some embodiments, multiple UPFs 1905 may be deployed (e.g., in different geographical locations), and the delivery of content to UE 1801 may be coordinated via the N9 interface. Similarly, UPF 1905 may receive uplink traffic from UE 1801 (e.g., via RAN 1810), and may forward the traffic toward DN 209. In some embodiments, UPF 1905 may implement, may be implemented by, may be communicatively coupled to, and/or may otherwise be associated with UPF/PGW-U 1835. In some embodiments, UPF 1905 may communicate (e.g., via the N4 interface) with SMF 1903, regarding user plane data processed by UPF 1905 (e.g., to provide analytics or reporting information, to receive policy and/or authorization information, etc.).

PCF 1907 may include one or more devices, systems, VNFs, CNFs, etc., that aggregate, derive, generate, etc. policy information associated with the 5GC and/or UEs 1801 that communicate via the 5GC and/or RAN 1810. PCF 1907 may receive information regarding policies and/or subscriptions from one or more sources, such as subscriber databases (e.g., UDM 1909, UDR 1913, etc.), and/or from one or more users such as, for example, an administrator associated with PCF 1907. In some embodiments, the functionality of PCF 1907 may be split into multiple network functions or subsystems, such as access and mobility PCF (“AM-PCF”) 1917, session management PCF (“SM-PCF”) 1919, UE PCF (“UE-PCF”) 1921, and so on. Such different “split” PCFs may be associated with respective SBIs (e.g., AM-PCF 1917 may be associated with an Nampcf SBI, SM-PCF 1919 may be associated with an Nsmpcf SBI, UE-PCF 1921 may be associated with an Nuepcf SBI, and so on) via which other network functions may communicate with the split PCFs. The split PCFs may maintain information regarding policies associated with different devices, systems, and/or network functions.

NRF 1911 may include one or more devices, systems, VNFs, CNFs, etc. that maintain routing and/or network topology information associated with the 5GC. For example, NRF 1911 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 1913 may include one or more devices, systems, VNFs, CNFs, etc. that provide user and/or subscriber information, based on which PCF 1907 and/or other elements of environment 1900 may determine access policies, QoS policies, charging policies, or the like. In some embodiments, UDR 1913 may receive such information from UDM 1909 and/or one or more other sources.

NEF 1915 include one or more devices, systems, VNFs, CNFs, etc. that provide access to information, APIs, and/or other operations or mechanisms of the 5GC to devices or systems that are external to the 5GC. NEF 1915 may maintain authorization and/or authentication information associated with such external devices or systems, such that NEF 1915 is able to provide information, that is authorized to be provided, to the external devices or systems. Such information may be received from other network functions of the 5GC (e.g., as authorized by an administrator or other suitable entity associated with the 5GC), such as SMF 1903, UPF 1905, a charging function (“CHF”) of the 5GC, and/or other suitable network function. NEF 1915 may communicate with external devices or systems (e.g., external devices 1854) via DN 209 and/or other suitable communication pathways.

While environment 1900 is described in the context of a 5GC, as noted above, environment 1900 may, in some embodiments, include or implement one or more other types of core networks. For example, in some embodiments, environment 1900 may be or may include a converged packet core, in which one or more elements may perform some or all of the functionality of one or more 5GC network functions and/or one or more EPC network functions. For example, in some embodiments, AMF 1815 may include, may implement, may be implemented by, and/or may otherwise be associated with MME 1816; SMF 1903 may include, may implement, may be implemented by, and/or may otherwise be associated with SGW 1817; PCF 1907 may include, may implement, may be implemented by, and/or may otherwise be associated with a PCRF (e.g., PCF/PCRF 1825); NEF 1915 may include, may implement, may be implemented by, and/or may otherwise be associated with a SCEF (e.g., NEF/SCEF 1849); and so on.

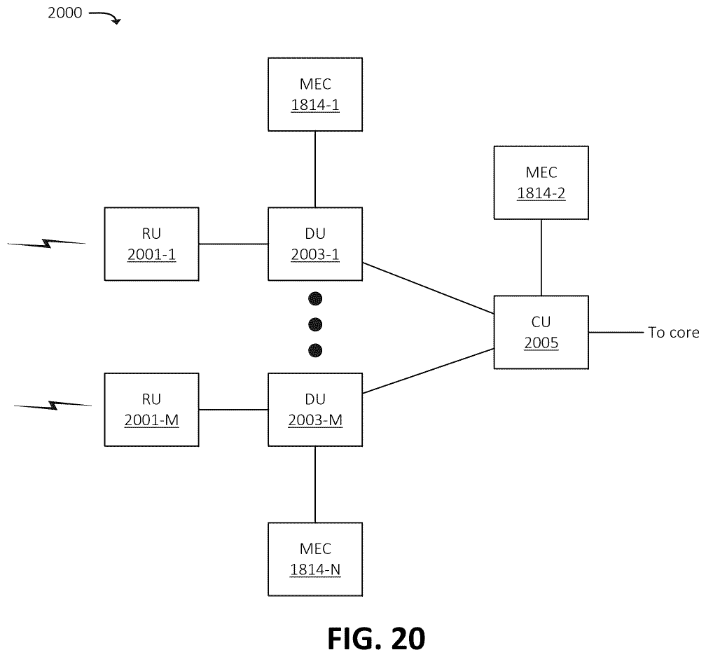

FIG. 20 illustrates an example RAN environment 2000, which may be included in and/or implemented by one or more RANs (e.g., RAN 1810 or some other RAN). In some embodiments, a particular RAN 1810 may include one RAN environment 2000. In some embodiments, a particular RAN 1810 may include multiple RAN environments 2000. In some embodiments, RAN environment 2000 may correspond to a particular gNB 1811 of RAN 1810. In some embodiments, RAN environment 2000 may correspond to multiple gNBs 1811. In some embodiments, RAN environment 2000 may correspond to one or more other types of base stations of one or more other types of RANs. As shown, RAN environment 2000 may include Central Unit (“CU”) 2005, one or more Distributed Units (“DUs”) 2003-1 through 2003-M (referred to individually as “DU 2003,” or collectively as “DUs 2003”), and one or more Radio Units (“RUs”) 2001-1 through 2001-M (referred to individually as “RU 2001,” or collectively as “RUs 2001”).

CU 2005 may communicate with a core of a wireless network (e.g., may communicate with one or more of the devices or systems described above with respect to FIG. 19, such as AMF 1815 and/or UPF 1905) and/or some other device or system such as MEC 1814. In the uplink direction (e.g., for traffic from UEs 1801 to a core network), CU 2005 may aggregate traffic from DUs 2003, and forward the aggregated traffic to the core network. In some embodiments, CU 2005 may receive traffic according to a given protocol (e.g., Radio Link Control (“RLC”) traffic) from DUs 2003, and may perform higher-layer processing (e.g., may aggregate/process RLC packets and generate Packet Data Convergence Protocol (“PDCP”) packets based on the RLC packets) on the traffic received from DUs 2003.

CU 2005 may receive downlink traffic (e.g., traffic from the core network, traffic from a given MEC 1814, etc.) for a particular UE 1801, and may determine which DU(s) 2003 should receive the downlink traffic. DU 2003 may include one or more devices that transmit traffic between a core network (e.g., via CU 2005) and UE 1801 (e.g., via a respective RU 2001). DU 2003 may, for example, receive traffic from RU 2001 at a first layer (e.g., physical (“PHY”) layer traffic, or lower PHY layer traffic), and may process/aggregate the traffic to a second layer (e.g., upper PHY and/or RLC). DU 2003 may receive traffic from CU 2005 at the second layer, may process the traffic to the first layer, and provide the processed traffic to a respective RU 2001 for transmission to UE 1801.

RU 2001 may include hardware circuitry (e.g., one or more RF transceivers, antennas, radios, and/or other suitable hardware) to communicate wirelessly (e.g., via an RF interface) with one or more UEs 1801, one or more other DUs 2003 (e.g., via RUs 2001 associated with DUs 2003), and/or any other suitable type of device. In the uplink direction, RU 2001 may receive traffic from UE 1801 and/or another DU 2003 via the RF interface and may provide the traffic to DU 2003. In the downlink direction, RU 2001 may receive traffic from DU 2003, and may provide the traffic to UE 1801 and/or another DU 2003.

One or more elements of RAN environment 2000 may, in some embodiments, be communicatively coupled to one or more MECs 1814. For example, DU 2003-1 may be communicatively coupled to MEC 1814-1, DU 2003-M may be communicatively coupled to MEC 1814-N, CU 2005 may be communicatively coupled to MEC 1814-2, and so on. MECs 1814 may include hardware resources (e.g., configurable or provisionable hardware resources) that may be configured to provide services and/or otherwise process traffic to and/or from UE 1801, via a respective RU 2001.

For example, DU 2003-1 may route some traffic, from UE 1801, to MEC 1814-1 instead of to a core network via CU 2005. MEC 1814-1 may process the traffic, perform one or more computations based on the received traffic, and may provide traffic to UE 1801 via RU 2001-1. As discussed above, MEC 1814 may include, and/or may implement, some or all of the functionality described above with respect to UPF 1905, AF 1830, and/or one or more other devices, systems, VNFs, CNFs, etc. In this manner, ultra-low latency services may be provided to UE 1801, as traffic does not need to traverse DU 2003, CU 2005, links between DU 2003 and CU 2005, and an intervening backhaul network between RAN environment 2000 and the core network.

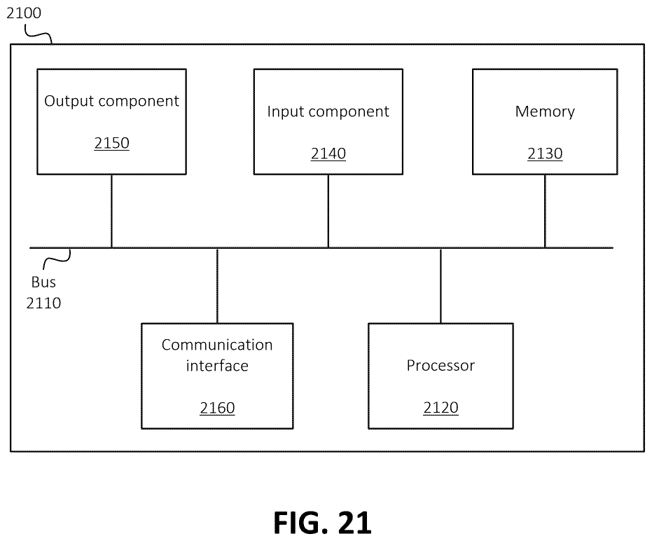

FIG. 21 illustrates example components of device 2100. One or more of the devices described above may include one or more devices 2100. Device 2100 may include bus 2110, processor 2120, memory 2130, input component 2140, output component 2150, and communication interface 2160. In another implementation, device 2100 may include additional, fewer, different, or differently arranged components.

Bus 2110 may include one or more communication paths that permit communication among the components of device 2100. Processor 2120 may include a processor, microprocessor, a set of provisioned hardware resources of a cloud computing system, a graphics processing unit (“GPU”), a GPU-based processing unit, a neural processing unit (“NPU”), or other suitable type of hardware that interprets and/or executes instructions (e.g., processor-executable instructions). In some embodiments, processor 2120 may be or may include one or more hardware processors. Memory 2130 may include any type of dynamic storage device that may store information and instructions for execution by processor 2120, and/or any type of non-volatile storage device that may store information for use by processor 2120.

Input component 2140 may include a mechanism that permits an operator to input information to device 2100 and/or other receives or detects input from a source external to input component 2140, such as a touchpad, a touchscreen, a keyboard, a keypad, a button, a switch, a microphone or other audio input component, etc. In some embodiments, input component 2140 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 2150 may include a mechanism that outputs information to the operator, such as a display, a speaker, one or more light emitting diodes (“LEDs”), etc.

Communication interface 2160 may include any transceiver-like mechanism that enables device 2100 to communicate with other devices and/or systems (e.g., via RAN 1810, RAN 1812, DN 209, etc.). For example, communication interface 2160 may include an Ethernet interface, an optical interface, a coaxial interface, or the like. Communication interface 2160 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 2100 may include more than one communication interface 2160. For instance, device 2100 may include an optical interface, a wireless interface, an Ethernet interface, and/or one or more other interfaces.

Device 2100 may perform certain operations relating to one or more processes described above. Device 2100 may perform these operations in response to processor 2120 executing instructions, such as software instructions, processor-executable instructions, etc. stored in a computer-readable medium, such as memory 2130. A computer-readable medium may be defined as a non-transitory memory device. A memory device may include space within a single physical memory device or spread across multiple physical memory devices. The instructions may be read into memory 2130 from another computer-readable medium or from another device. The instructions stored in memory 2130 may be processor-executable instructions that cause processor 2120 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-17), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set. Concepts described above may be embodied by, for example, a device, devices, a system, systems, a method, methods, a non-transitory computer-readable medium, and/or non-transitory computer-readable media, as provided for in the claims.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
receive downlink formatting information associated with a plurality of different Internet of Things (“IoT”) devices, wherein the downlink formatting information for different IoT devices includes different downlink formatting information, wherein the downlink formatting information for a particular IoT device of the plurality of IoT devices includes a format of configuration instructions used to configure one or more parameters of the particular IoT device;
generate, based on the downlink formatting information for the particular IoT device, a user interface (“UI”) that includes an option to configure the one or more parameters of the particular IoT device;
present the UI, including the option to configure the one or more parameters of the particular IoT device, to a user device;
receive, from the user device, a selection of a particular option to configure a particular parameter of the one or more parameters of the particular IoT device;
generate a set of configuration instructions based on the received selection of the particular option, wherein the set of configuration instructions is generated further based on the format of configuration instructions included in the downlink formatting information for the particular IoT device; and
output the set of configuration instructions to the IoT device, wherein the IoT device modifies the particular parameter based on receiving the set of configuration instructions.

2. The device of claim 1, wherein the downlink formatting information for the particular IoT device specifies at least one of:
an application programming interface (“API”) implemented by the particular IoT device, or
a protocol implemented by the particular IoT device.

3. The device of claim 1, wherein the set of configuration instructions is a first set of configuration instructions, wherein the one or more processors are further configured to:
maintain information indicating a type of gateway to which the particular IoT device is connected;
generate a second set of configuration instructions for the gateway based on the received selection of the particular option; and
output the second set of configuration instructions to the gateway, with the gateway modifies one or more parameters of the gateway based on the second set of configuration instructions.

4. The device of claim 3, wherein the gateway includes:
a Bluetooth Low Energy (“BLE”) gateway, or
a Long Range Wide Area Network (“LoRaWAN”) gateway.

5. The device of claim 3, wherein the one or more parameters of the gateway include at least one of:
a wake interval parameter, or
a sleep interval parameter.

6. The device of claim 5, wherein the set of configuration instructions provided to the IoT device include at least one of:
the wake interval parameter, or
the sleep interval parameter.

7. The device of claim 1, wherein the one or more parameters of the particular IoT device are identified based on a set of uplink formatting information associated with the particular IoT device.

8. A non-transitory computer-readable medium, storing a plurality of processor-executable instructions to:
receive downlink formatting information associated with a plurality of different Internet of Things (“IoT”) devices, wherein the downlink formatting information for different IoT devices includes different downlink formatting information, wherein the downlink formatting information for a particular IoT device of the plurality of IoT devices includes a format of configuration instructions used to configure one or more parameters of the particular IoT device;
generate, based on the downlink formatting information for the particular IoT device, a user interface (“UI”) that includes an option to configure the one or more parameters of the particular IoT device;
present the UI, including the option to configure the one or more parameters of the particular IoT device, to a user device;
receive, from the user device, a selection of a particular option to configure a particular parameter of the one or more parameters of the particular IoT device;
generate a set of configuration instructions based on the received selection of the particular option, wherein the set of configuration instructions is generated further based on the format of configuration instructions included in the downlink formatting information for the particular IoT device; and
output the set of configuration instructions to the IoT device, wherein the IoT device modifies the particular parameter based on receiving the set of configuration instructions.

9. The non-transitory computer-readable medium of claim 8, wherein the downlink formatting information for the particular IoT device specifies at least one of:
an application programming interface (“API”) implemented by the particular IoT device, or
a protocol implemented by the particular IoT device.

10. The non-transitory computer-readable medium of claim 8, wherein the set of configuration instructions is a first set of configuration instructions, wherein the plurality of processor-executable instructions further include processor-executable instructions to:
maintain information indicating a type of gateway to which the particular IoT device is connected;
generate a second set of configuration instructions for the gateway based on the received selection of the particular option; and
output the second set of configuration instructions to the gateway, with the gateway modifies one or more parameters of the gateway based on the second set of configuration instructions.

11. The non-transitory computer-readable medium of claim 10, wherein the gateway includes:
a Bluetooth Low Energy (“BLE”) gateway, or
a Long Range Wide Area Network (“LoRaWAN”) gateway.

12. The non-transitory computer-readable medium of claim 10, wherein the one or more parameters of the gateway include at least one of:
a wake interval parameter, or
a sleep interval parameter.

13. The non-transitory computer-readable medium of claim 12, wherein the set of configuration instructions provided to the IoT device include at least one of:
the wake interval parameter, or
the sleep interval parameter.

14. The non-transitory computer-readable medium of claim 8, wherein the one or more parameters of the particular IoT device are identified based on a set of uplink formatting information associated with the particular IoT device.

15. A method, comprising:
receiving downlink formatting information associated with a plurality of different Internet of Things (“IoT”) devices, wherein the downlink formatting information for different IoT devices includes different downlink formatting information, wherein the downlink formatting information for a particular IoT device of the plurality of IoT devices includes a format of configuration instructions used to configure one or more parameters of the particular IoT device;
generating, based on the downlink formatting information for the particular IoT device, a user interface (“UI”) that includes an option to configure the one or more parameters of the particular IoT device;
presenting the UI, including the option to configure the one or more parameters of the particular IoT device, to a user device;
receiving, from the user device, a selection of a particular option to configure a particular parameter of the one or more parameters of the particular IoT device;
generating a set of configuration instructions based on the received selection of the particular option, wherein the set of configuration instructions is generated further based on the format of configuration instructions included in the downlink formatting information for the particular IoT device; and
outputting the set of configuration instructions to the IoT device, wherein the IoT device modifies the particular parameter based on receiving the set of configuration instructions.

16. The method of claim 15, wherein the downlink formatting information for the particular IoT device specifies at least one of:
an application programming interface (“API”) implemented by the particular IoT device, or
a protocol implemented by the particular IoT device.

17. The method of claim 15, wherein the set of configuration instructions is a first set of configuration instructions, the method further comprising:
maintaining information indicating a type of gateway to which the particular IoT device is connected;
generating a second set of configuration instructions for the gateway based on the received selection of the particular option; and
outputting the second set of configuration instructions to the gateway, with the gateway modifies one or more parameters of the gateway based on the second set of configuration instructions.

18. The method of claim 17, wherein the one or more parameters of the gateway include at least one of:
a wake interval parameter, or
a sleep interval parameter.

19. The method of claim 18, wherein the set of configuration instructions provided to the IoT device include at least one of:
the wake interval parameter, or
the sleep interval parameter.

20. The method of claim 15, wherein the one or more parameters of the particular IoT device are identified based on a set of uplink formatting information associated with the particular IoT device.
